(19) United States
(12) Patent Application Publication
(10) Pub. No.: US 2025/0386032 A1
(43) Pub. Date: Dec. 18, 2025

(54) TECHNIQUES OF INTRA PREDICTION

(71) Applicant: Tencent America LLC, Palo Alto, CA (US)

(72) Inventors: Yonguk YOON, Palo Alto, CA (US); Lien-Fei CHEN, Palo Alto, CA (US); Roman CHERNYAK, Santa Clara, CA (US); Ziyue XIANG, Palo Alto, CA (US); Biao WANG, San Jose, CA (US); Motong XU, Palo Alto, CA (US); Yifan WANG, Palo Alto, CA (US); Shan LIU, San Jose, CA (US); Xin ZHAO, San Jose, CA (US)

(73) Assignee: Tencent America LLC, Palo Alto, CA (US)

(21) Appl. No.: 19/236,738

(22) Filed: Jun. 12, 2025

Related U.S. Application Data
(60) Provisional application No. 63/659,714, filed on Jun. 13, 2024.
(60) Provisional application No. 63/679,575, filed on Aug. 5, 2024.
(60) Provisional application No. 63/708,708, filed on Oct. 17, 2024.
(60) Provisional application No. 63/712,388, filed on Oct. 25, 2024.
(60) Provisional application No. 63/712,992, filed on Oct. 28, 2024.
(60) Provisional application No. 63/716,716, filed on Nov. 5, 2024.

(51) Int. Cl. H04N 19/159; H04N 19/132; H04N 19/176; H04N 19/196; H04N 19/54; H04N 19/593

(52) U.S. Cl. CPC H04N 19/159; H04N 19/132; H04N 19/176; H04N 19/196; H04N 19/54; H04N 19/593

(57) ABSTRACT

A coded video bitstream is received. The coded video bitstream includes coded information of a current block in a current picture, the coded information indicates that the current block is coded by an intra prediction using an affine intra mode (AIM) model. The affine intra mode model for applying on the current block is determined. At least a first intra angular mode for a first sample in the current block and a second intra angular mode for a second sample in the current block are determined according to the affine intra mode model, the first intra angular mode is different from the second intra angular mode. The current block is reconstructed based on the intra prediction using the affine intra mode model, the first sample is predicted based on the first intra angular mode and the second sample is predicted based on the second intra angular mode.

### INCORPORATION BY REFERENCE

The present application claims the benefit of priority to U.S. Provisional Application No. 63/659,714, filed on Jun. 13, 2024, U.S. Provisional Application No. 63/679,575, filed on Aug. 5, 2024, U.S. Provisional Application No. 63/708,708, filed on Oct. 17, 2024, U.S. Provisional Application No. 63/712,388, filed on Oct. 25, 2024, U.S. Provisional Application No. 63/712,992, filed on Oct. 28, 2024, and U.S. Provisional Application No. 63/716,716, filed on Nov. 5, 2024. The entire disclosures of the prior applications are hereby incorporated by reference.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression can help transmit image/video data across different devices, storage and networks with minimal quality degradation. In some examples, video codec technology can compress video based on spatial and temporal redundancy. In an example, a video codec can use techniques referred to as intra prediction that can compress an image based on spatial redundancy. For example, the intra prediction can use reference data from the current picture under reconstruction for sample prediction. In another example, a video codec can use techniques referred to as inter prediction that can compress an image based on temporal redundancy. For example, the inter prediction can predict samples in a current picture from a previously reconstructed picture with motion compensation. The motion compensation can be indicated by a motion vector (MV).

### SUMMARY

Aspects of the disclosure include bitstreams, methods and apparatuses for video encoding/decoding. In some examples, an apparatus for video encoding/decoding includes processing circuitry.

Some aspects of the disclosure provide a method of video decoding. In an example, a coded video bitstream is received. The coded video bitstream includes coded information of a current block in a current picture, the coded information indicates that the current block is coded by an intra prediction using an affine intra mode (AIM) model. The affine intra mode model for applying on the current block is determined. At least a first intra angular mode for a first sample in the current block and a second intra angular mode for a second sample in the current block are determined according to the affine intra mode model, the first intra angular mode is different from the second intra angular mode. The current block is reconstructed based on the intra prediction using the affine intra mode model, the first sample is predicted based on the first intra angular mode and the second sample is predicted based on the second intra angular mode.

Some aspects of the disclosure provide a method for video encoding. In an example, to code a current block in a current picture by an intra prediction using an affine intra mode model is determined. The affine intra mode model for applying on the current block is determined. At least a first intra angular mode for a first sample in the current block and a second intra angular mode for a second sample in the current block are determined according to the affine intra mode model, the first intra angular mode is different from the second intra angular mode. The current block is encoded into coded information of the current block based on the intra prediction using the affine intra mode model, the first sample is predicted based on the first intra angular mode and the second sample is predicted based on the second intra angular mode.

Some aspects of the disclosure provide a method of processing visual media data is provided. In the method, a conversion between a visual media file and a bitstream of visual media data is performed according to a format rule. In an example, the bitstream includes coded information of a current block in a current picture, the coded information indicates that the current block is coded by an intra prediction using an affine intra mode model. The format rule specifies that: the affine intra mode model for applying on the current block is determined; at least a first intra angular mode for a first sample in the current block and a second intra angular mode for a second sample in the current block are determined according to the affine intra mode model, the first intra angular mode being different from the second intra angular mode; and the current block is reconstructed based on the intra prediction using the affine intra mode model, the first sample being predicted based on the first intra angular mode and the second sample being predicted based on the second intra angular mode.

Aspects of the disclosure also provide an apparatus for video decoding. The apparatus for video encoding including processing circuitry configured to implement any of the described methods for video decoding.

Aspects of the disclosure also provide an apparatus for video encoding. The apparatus for video encoding including processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system.

FIG. 2 is a schematic illustration of an example of a block diagram of a decoder.

FIG. 3 is a schematic illustration of an example of a block diagram of an encoder.

FIG. 4 shows a diagram of intra prediction modes in some examples.

FIG. 5 shows another diagram of intra prediction modes in some examples.

FIG. 6 shows a diagram of relationship of an angle with a unit vector in an example.

FIG. 7 shows examples of derived intra modes for samples in coding blocks based on neighboring intra mode angles.

FIG. 8 shows a diagram of a current coding unit with a plurality of neighboring samples,

FIG. 9 shows a flow chart outlining a process according to an aspect of the disclosure.

FIG. 10 shows a flow chart outlining a process according to an aspect of the disclosure.

FIG. 11 shows a diagram of a current block with multiple reference lines in some examples.

FIG. 12 shows a flow chart outlining a process according to an aspect of the disclosure.

FIG. 13 shows a flow chart outlining a process according to an aspect of the disclosure.

FIG. 14 shows a diagram of angle prediction in some examples.

FIG. 15 shows another diagram of angle prediction in some examples.

FIG. 16 shows a flow chart outlining a process according to an aspect of the disclosure.

FIG. 17 shows a flow chart outlining a process according to an aspect of the disclosure.

FIG. 18 shows a flow chart outlining a process according to an aspect of the disclosure.

FIG. 19 shows a flow chart outlining a process according to an aspect of the disclosure.

FIG. 20 shows a diagram of a linear weight derivation function in an example.

FIG. 21 shows a flow chart outlining a process according to an aspect of the disclosure.

FIG. 22 shows a flow chart outlining a process according to an aspect of the disclosure.

FIGS. 23A-23D show examples of the classifier usage for the intra prediction mode.

FIG. 24 shows a diagram of a pre-defined area including no-adjacent blocks in an example.

FIG. 25 shows a flow chart outlining a process according to an aspect of the disclosure.

FIG. 26 shows a flow chart outlining a process according to an aspect of the disclosure.

FIG. 27 is a schematic illustration of a computer system in accordance with an aspect.

### DETAILED DESCRIPTION

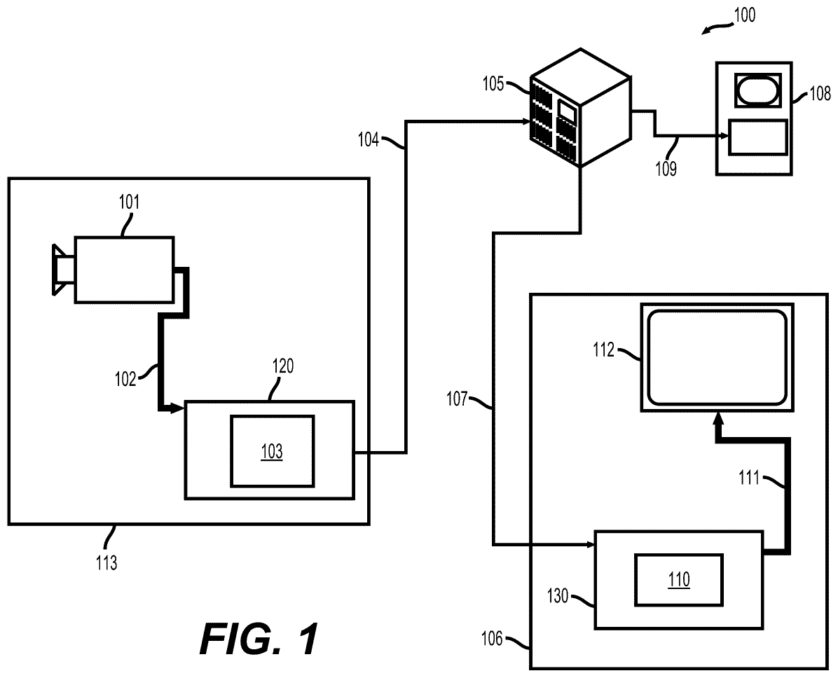

FIG. 1 shows a block diagram of a video processing system (100) in some examples. The video processing system (100) is an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

The video processing system (100) includes a capture subsystem (113), that can include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), can be processed by an electronic device (120) that includes a video encoder (103) coupled to the video source (101). The video encoder (103) can include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), can be stored on a streaming server (105) for future use. One or more streaming client subsystems, such as client subsystems (106) and (108) in FIG. 1 can access the streaming server (105) to retrieve copies (107) and (109) of the encoded video data (104). A client subsystem (106) can include a video decoder (110), for example, in an electronic device (130). The video decoder (110) decodes the incoming copy (107) of the encoded video data and creates an outgoing stream of video pictures (111) that can be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

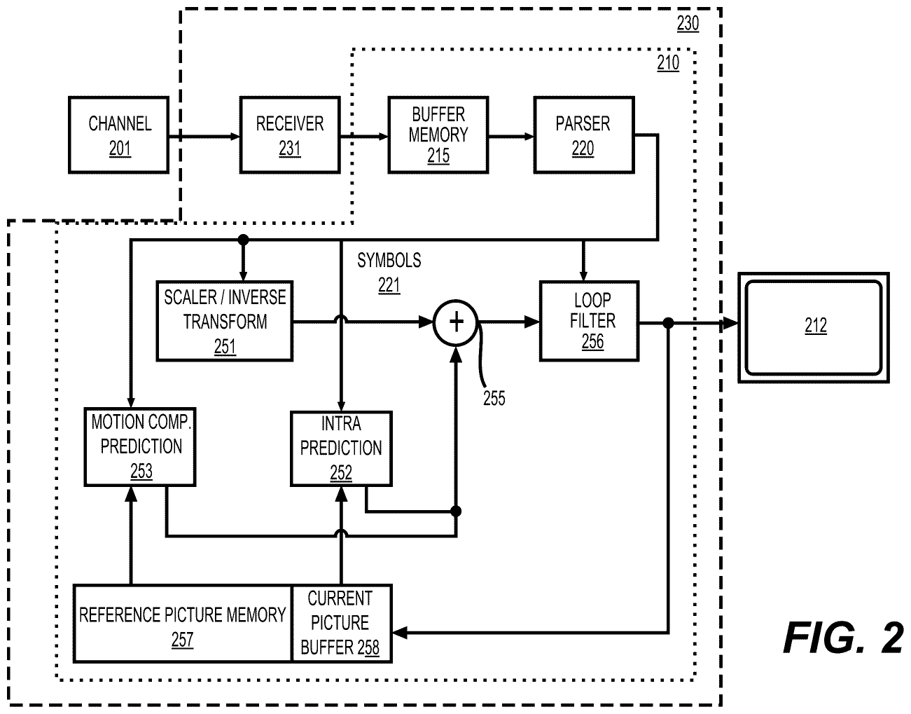

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may at least partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

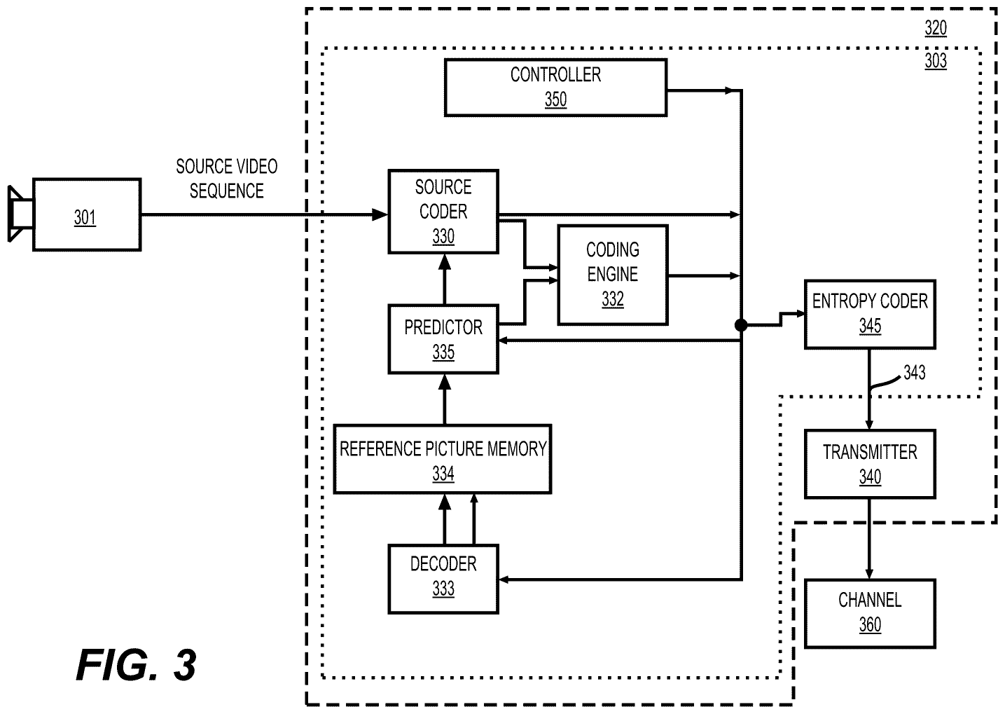

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Aspects of the disclosure provide techniques (e.g., methods, embodiments, encoders, decoders) for decoder side intra mode derivation, such as multi-template decoder side intra mode derivation. The techniques in the present disclosure may be used separately or combined in any order. Further, each of the techniques may be implemented by processing circuitry (e.g., one or more processors or one or more integrated circuits). In one example, the one or more processors execute a program that is stored in a non-transitory computer-readable medium.

Video coding has been widely used in many applications. Video coding standards, such as H264, H265, H266 (VVC), AV 1 and AVS, can be adopted in video codec for video coding.

Intra prediction techniques can be used video and/or image coding to use reference data from a current picture under reconstruction for sample prediction. Intra prediction modes are used in some intra prediction techniques.

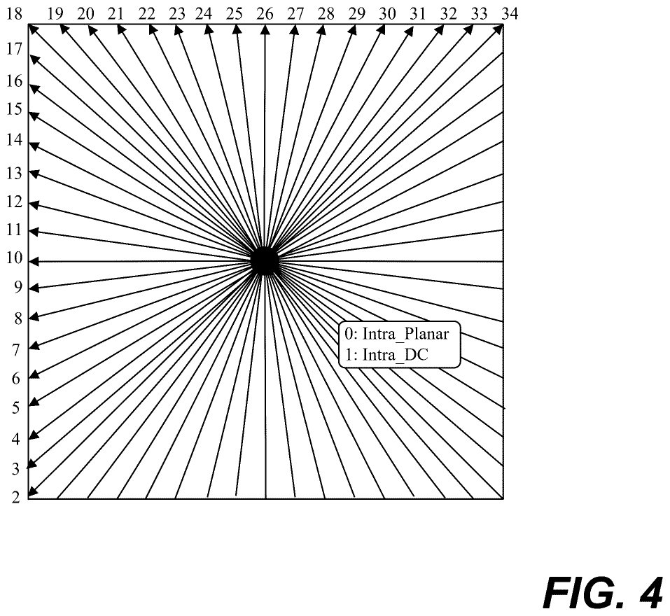

FIG. 4 shows a diagram of intra prediction modes in some examples, such as HEVC. For example, HEVC uses a total of 35 intra prediction modes (e.g., mode 0 to mode 34). Among the 35 intra prediction modes, some modes are directional modes and some modes are non directional modes. In some examples, mode 0 and mode 1 are non directional modes, for example, mode 0 is a planar mode, and mode 1 is DC mode. Further, mode 2 to mode 34 can be directional modes, for example, mode 10 is horizontal mode, mode 26 is vertical mode, and mode 2, mode 18 and mode 34 are diagonal modes, and the like. Values of samples in a coding block are determined according to the neighboring references samples in the same picture and the intra prediction mode of the coding block. In an example, in the DC mode, a mean value is calculated by averaging reference samples in the same picture and can be used for flat surfaces. In another example, in the planar mode, the value of each sample in the coding block is calculated assuming an amplitude surface with a horizontal and vertical smooth gradient derived from the boundaries samples of the neighboring blocks. In some examples, the reference samples include neighboring samples in a row immediately above the coding block and/or include neighboring samples in a column immediately left of the coding block.

In some examples, the intra prediction modes are signaled based on a list of most probable modes (MPMs), and remaining modes. For example, for a coding block, an MPM list is determined. In an example, the MPM list includes 3 modes from the 35 intra prediction modes. Then, when the specific intra prediction mode of the coding block is one of the 3 modes in the MPM list, an index indicative of the one of the 3 modes is used for signaling. When the specific intra prediction mode of the coding block is not one of the 3 modes in the MPM list, an index indicative of one from the remaining modes (32 modes) is used for signaling. In some examples, the MPM list can include other suitable number of modes, such as 6, 10, and the like.

It is noted other suitable number of intra prediction modes can be used.

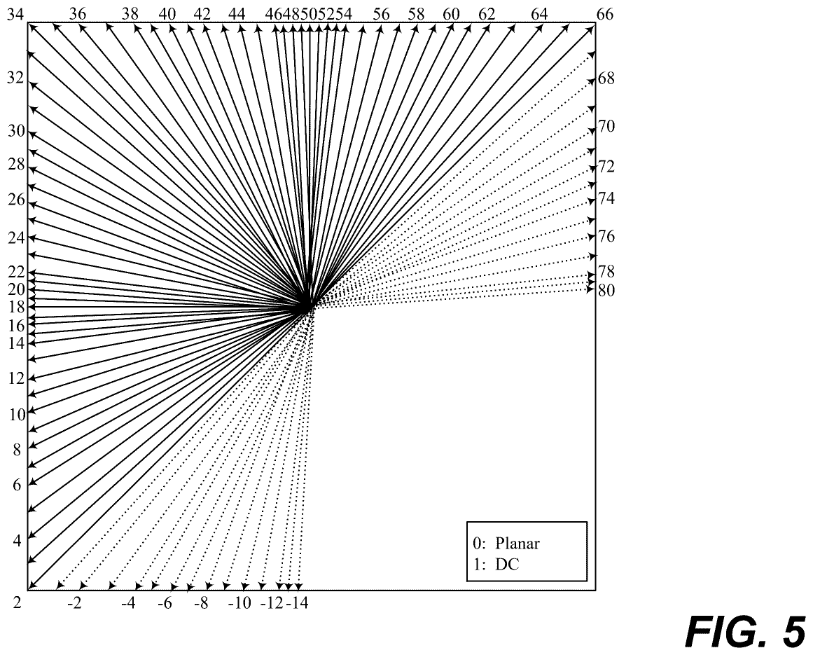

FIG. 5 shows a diagram of intra prediction modes in some examples, such as VVC. In some examples, VVC can use a total of 95 intra prediction modes, such as mode −14 to mode 80. Among the 95 intra prediction modes, mode 0 is a planar mode (a non-directional prediction mode), mode 1 is DC mode (a non-directional prediction mode), mode 18 is horizontal mode, mode 50 is vertical mode, and mode 2, mode 34 and mode 66 are diagonal modes. Modes −1 to −14 and modes 67 to 80 are referred to wide-angle intra prediction (WAIP) modes in some examples.

In some examples, to code an intra mode (also referred to as intra prediction mode) of a coding block (e.g., a luma block, chroma blocks of a coding unit), a most probable mode (MPM) list of size 3 is built based on the intra modes of the neighboring blocks of the coding block. The MPM list can be referred to as the MPM list or primary MPM list. If the intra mode of the coding block is not from the MPM list, a flag is signaled to indicate whether intra mode belongs to the selected modes in the MPM list.

In some examples, when an intra prediction mode of a current block is determined, samples in the current block can be generated based on reference samples, such as neighboring samples that already reconstructed.

Intra prediction explores spatial redundancy between a current block and neighboring samples of the current block. For example, to code a block using intra prediction, multiple intra prediction modes can be defined, and a selection of one of the multiple intra prediction modes can be predicted and/or signaled. Different intra prediction modes can generate prediction sample values using different predefined models. The different predefined models may include (1) averaging neighboring samples, (2) interpolating the prediction samples using neighboring samples with a given prediction direction, such as in an angular intra prediction mode, and the like to predict a sample in the current block. In some examples, due to the correlation of spatial textures in image and/or video content, intra prediction modes selected for adjacent blocks are highly correlated. Accordingly, intra prediction mode(s) of the current block may not need to be signaled. Instead, the intra prediction mode(s) of the current block can be derived by analyzing a template of the current block.

In various related examples (e.g. VCC), for intra prediction of a coding block, an intra prediction of the whole coding block (e.g., samples in the whole coding block) is based on a specific intra prediction mode that represents the directional or non-directional texture characteristics of the coding block.

Some aspects of the disclosure provide techniques of an affine intra prediction. Samples in a coding block can have different intra prediction modes (also referred to as intra modes). In some aspects, an intra angular mode (also referred to as directional mode) for each sample in the coding block is derived based on an affine model that is also referred to as affine intra model or affine intra mode (AIM) model. The AIM model can be derived from the intra angular mode of the neighbouring blocks or be signaled in the bitstream.

Some aspects of the disclosure provide techniques to derive the AIM model. In some examples (also referred to as a first solution), a vector based AIM model derivation can be used to derive intra mode for each sample. In some examples (also referred to as a second solution), an angle based AIM model derivation can be used to derive intra mode for each sample.

For example, in the first solution, each of existing intra angular modes can have an angle (denoted by θₘ) associated with the intra angular mode. When the angle (θₘ) is available, the angle can be replaced by a unit vector denoted by vₘ=[cos θₘ, sin θₘ]^{T}.

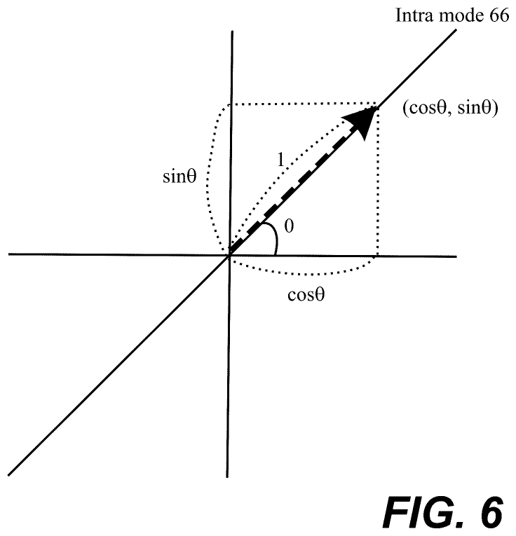

FIG. 6 shows a diagram of relationship of an angle with a unit vector in an example. In the FIG. 6 example, the intra mode 66 corresponds to 45° (e.g., θₘ=45°), and the unit vector vₘ=[\sqrt{2}/2, \sqrt{2}/2]^{T}.

In some aspects, an (directional) intra mode can be represented by a unit vector, and neighboring intra modes can be converted to unit vectors and the unit vectors can be utilized to derive an AIM model (also referred to as vector based AIM model), and the technique to derive the AIM model using the unit vectors is referred to as vector based AIM model derivation.

In some examples, the AIM model equation can be defined according to Eq. (1) and Eq. (2):

$${v}_{x} = {a}_{11} x + {a}_{12} y + {a}_{13} \qquad Eq . ( 1 )$$

$${v}_{y} = {a}_{21} x + {a}_{22} y + {a}_{23} \qquad Eq . ( 2 )$$

where α₁₁, α₁₂, α₁₃, α₂₁, α₂₂ and α₂₃ are model coefficients. Further, the AIM model equation can be rewritten as Eq. (3) and Eq. (4)

$$Aa = b , \qquad Eq . ( 3 )$$

$$A = [ \begin{matrix}{a}_{11} & {a}_{12} & {a}_{13} \\ {a}_{21} & {a}_{22} & {a}_{23} \\ 0 & 0 & 1\end{matrix} ] , a = [ \begin{matrix}\begin{matrix}x \\ y\end{matrix} \\ 1\end{matrix} ] , b = [ \begin{matrix}{v}_{x} \\ {v}_{y} \\ 1\end{matrix} ] \qquad Eq . ( 4 )$$

In some examples, to solve the AIM model equation, three neighboring intra modes (intra modes at neighboring positions of the coding block) are used, and the three neighboring intra modes are referred to as control point intra modes (CPIMs). For example, the three CPIMs are denoted by m1, m2, and m3 that are intra angular modes at (0, 0), (W, 0), and (0, H) respectively when the current block size is (W, H). The unit vectors of the CPIMs can be represented by Eq. (5)-Eq. (7):

$${v}_{m 1} = {[ {cos θ}_{m 1} , sin {θ}_{m 1} ]}^{T} at ( 0 , 0 ) \qquad Eq . ( 5 )$$

$${v}_{m 2} = {[ {cos θ}_{m 2} , sin {θ}_{m 2} ]}^{T} at ( W , 0 ) \qquad Eq . ( 6 )$$

$${v}_{m 3} = {[ cos {θ}_{m 3} , sin {θ}_{m 3} ]}^{T} at ( 0 , H ) \qquad Eq . ( 7 )$$

In some aspects, the neighboring intra modes can be used to derive the model coefficients of the vector based AIM model, such as according to Eq. (8)

$$\{ \begin{matrix}{v}_{x} = ( \frac{cos {θ}_{m 2} - cos {θ}_{m 1}}{W} ) x + ( \frac{cos {θ}_{m 3} - cos {θ}_{m 1}}{H} ) y + cos {θ}_{m 1} \\ {v}_{y} = ( \frac{sin {θ}_{m 2} - sin {θ}_{m 1}}{W} ) x + ( \frac{sin {θ}_{m 3} - sin {θ}_{m 1}}{H} ) y + sin {θ}_{m 1}\end{matrix} \qquad Eq . ( 8 )$$

In some aspects, according to a sample position (x, y) in the current block, a vector is derived by the vector based AIM model Eq. (8). The vector can be converted to an intra mode, and the sample at the sample position can be predicted using derived intra mode.

In another example, in the second solution, an angle (θₘ) associated with an intra mode (m) can be derived using the angle based AIM model. For example, the angle based AIM model equation can be defined according to Eq. (9)

$$θ = {a}_{1} x + {a}_{2} y + {a}_{3} , \qquad Eq . ( 9 )$$

where α₁, α₂, and α₃ are the model coefficients. In some examples, to solve the angle AIM model equation, three neighboring angles of intra modes are used as control point intra modes (CPIMs). For example, the Eq. (9) equation can be rewritten as Eq. (10)-Eq. (11)

$$Aa = b , \qquad Eq . ( 10 )$$

$$A = [ \begin{matrix}{x}_{1} & {y}_{1} & 1 \\ {x}_{2} & {y}_{2} & 1 \\ {x}_{3} & {y}_{3} & 1\end{matrix} ] , a = [ \begin{matrix}{a}_{1} \\ {a}_{2} \\ {a}_{3}\end{matrix} ] , b = [ \begin{matrix}{θ}_{m 1} \\ {θ}_{m 2} \\ {θ}_{m 3}\end{matrix} ] \qquad Eq . ( 11 )$$

where (x₁, y₁), (x₂, y₂), and (x₃, y₃) are locations of the three neighboring angles of intra modes, such as (0, 0), (W, 0), and (0, H) respectively when the current block size is (W, H) in an example.

In some examples, using the least square solution, the equation can be solved and the coefficients (α₁, α₂, and α₃) are derived.

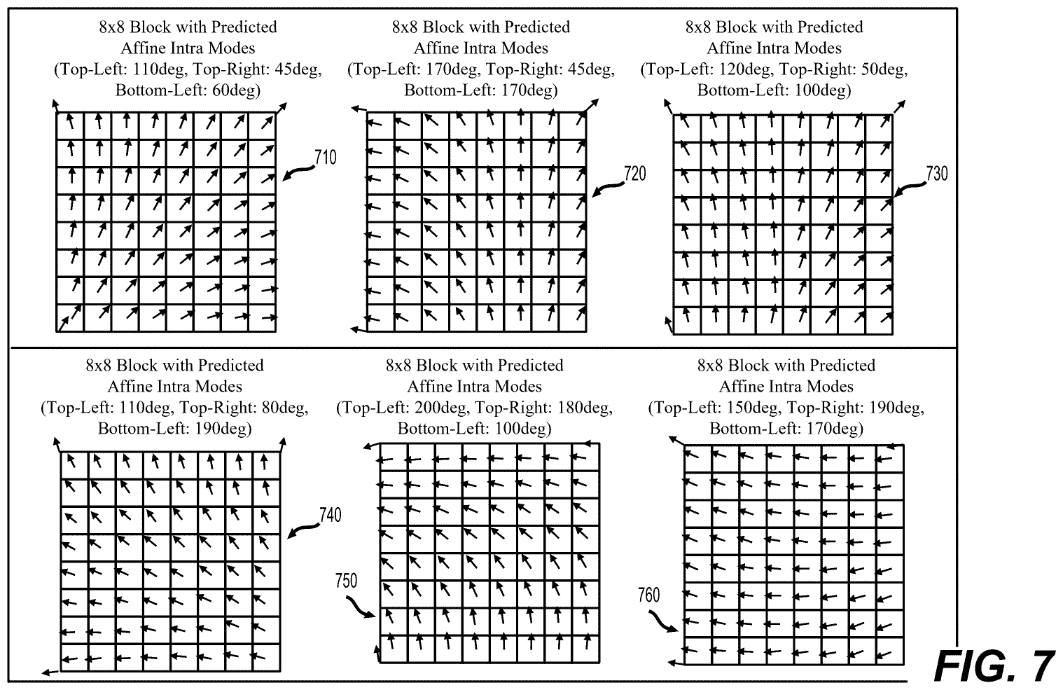

FIG. 7 shows examples of derived intra modes for samples in coding blocks based on neighboring intra mode angles. Each sample can be predicted using own intra mode.

In the FIG. 7 example, a coding block (710) is an 8×8 block predicted using an AIM model. The AIM model is derived based on a top-left neighboring intra mode corresponding to 110°, a top right neighboring intra mode corresponding to 45°, and a bottom left neighboring intra mode corresponding to 60°. The AIM model is used to determine respective intra modes for samples in the coding block (710). Each sample in the coding block (710) can be predicted using its own intra mode.

In the FIG. 7 example, a coding block (720) is an 8×8 block predicted using an AIM model. The AIM model is derived based on a top-left neighboring intra mode corresponding to 170°, a top right neighboring intra mode corresponding to 45°, and a bottom left neighboring intra mode corresponding to 170°. The AIM model is used to determine respective intra modes for samples in the coding block (720). Each sample in the coding block (720) can be predicted using its own intra mode.

In the FIG. 7 example, a coding block (730) is an 8×8 block predicted using an AIM model. The AIM model is derived based on a top-left neighboring intra mode corresponding to 120°, a top right neighboring intra mode corresponding to 50°, and a bottom left neighboring intra mode corresponding to 100°. The AIM model is used to determine respective intra modes for samples in the coding block (730). Each sample in the coding block (730) can be predicted using its own intra mode.

In the FIG. 7 example, a coding block (740) is an 8×8 block predicted using an AIM model. The AIM model is derived based on a top-left neighboring intra mode corresponding to 110°, a top right neighboring intra mode corresponding to 80°, and a bottom left neighboring intra mode corresponding to 190°. The AIM model is used to determine respective intra modes for samples in the coding block (740). Each sample in the coding block (740) can be predicted using its own intra mode.

In the FIG. 7 example, a coding block (750) is an 8×8 block predicted using an AIM model. The AIM model is derived based on a top-left neighboring intra mode corresponding to 200°, a top right neighboring intra mode corresponding to 180°, and a bottom left neighboring intra mode corresponding to 100°. The AIM model is used to determine respective intra modes for samples in the coding block (750). Each sample in the coding block (750) can be predicted using its own intra mode.

In the FIG. 7 example, a coding block (760) is an 8×8 block predicted using an AIM model. The AIM model is derived based on a top-left neighboring intra mode corresponding to 150°, a top right neighboring intra mode corresponding to 190°, and a bottom left neighboring intra mode corresponding to 170°. The AIM model is used to determine respective intra modes for samples in the coding block (760). Each sample in the coding block (760) can be predicted using its own intra mode.

According to some aspects of the disclosure, an intra angular mode (also referred to as directional intra mode) for each sample in a coding block is derived based on an affine model (e.g., AIM model, vector based AIM model, angle based AIM model and the like. The affine model can be derived from the intra angular mode(s) of the neighbouring blocks or be signaled in a bitstream.

In some aspects, in order to define affine model, information from intra modes, such as at least one of angles, vectors, values of cosine, values of sine, values of tangent, and the like that depend on the angles of the intra modes can be utilized.

In some aspects, when angles are used to derive the affine model, pre-defined angle table for each intra angular mode can be utilized. For example, the pre-defined angle table maps between intra angular modes to angles. For an angle, the pre-defined angle table can be used determine one or more intra modes for the angle. For an intra mode, the pre-defined angle table can be used to determine an angle associated with the intra mode.

In some aspects, a flag is signaled to indicate whether the affine intra mode is used or not on a current block. When the flag is true, each sample within the current block can have a different directional intra angular mode for each sample, the directional intra angular modes for samples in the current block are derived using an affine model.

In some aspects, the number of CPIMs can differ depending on availability of neighboring angular modes. The AIM model can be derived utilizing given CPIMs.

In some examples, when two neighboring intra angular modes are available, the AIM model can be derived using two CPIMs (respectively of the two neighboring intra angular modes).

In some examples, when two neighboring intra angular modes are available, another CPIM (a third CPIM) can be derived using existing two CPIMs (respectively of the two neighboring intra angular modes) and the AIM model can be derived using three CPIMs.

In some examples, when three neighboring intra angular modes are available, the affine intra model can be derived using three CPIMs (respectively of the three neighboring intra angular modes).

In some aspects, when a plurality of neighboring angular modes are available, all possible combinations (also referred to as combination candidates) of CPIMs can be constructed to form a list. An affine model (e.g., AIM model) can be derived from a combination candidate in the list. An index is signaled to indicate which combination candidate in the list is used to derive the affine model (AIM model).

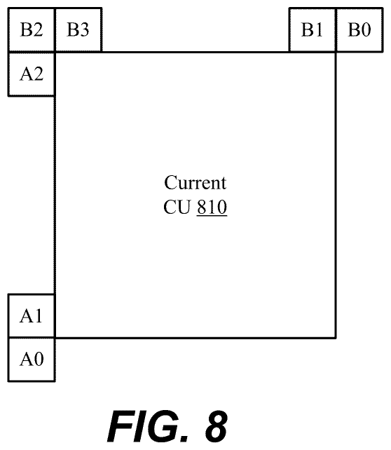

FIG. 8 shows a diagram of a current coding unit (810) with a plurality of neighboring samples, such as shown by A0, A1, A2, B0, B1, B2 and B3 in FIG. 8. The intra modes at the neighboring samples can be used to derive AIM model.

In some examples, each position's CPIM (e.g., top-left CPIM, top-right CPIM, and left-bottom CPIM) can be one of angular modes from pre-defined sample positions as shown in FIG. 8. For example, CPIM of top-left can be one of angular modes of A2, B2, and B3. CPIM of top-right can be one of angular modes of B0 and B1. CPIM of left-bottom can be one of angular modes of A0 and A1. According to availability of neighboring angular modes, a candidate can be built using available angular modes from each position.

In some aspects, the affine intra model (e.g., AIM model) can be derived by a regression model using all possible neighboring intra angular modes adjacent to the current block. For example, an AIM model can be derived by a regression model using all of the intra angular modes at A0, A1, A2, B0, B1, B2 and B3 in FIG. 8.

In some aspects, when a neighboring intra prediction mode is not angular mode, the neighboring intra prediction mode can be replaced by an angular mode. The angular mode can be used as a CPIM. In some examples, the non-angular mode can be replaced to one of default angular modes. The default angular modes can be fixed or the default angular modes can be determined based on at least one of block size, block shape, or other coded information of the block.

In some examples, the non-angular mode can be replaced to an angular mode that is derived using decoder-side intra mode derivation method. For example, the decoder side intra mode derivation method can derive the angular mode from a template of the current block, the template includes a group of adjacent reference samples of the current block.

In some examples, the non-angular mode can be replaced to an angular mode that is derived from a reference block indicated by at least one of motion vector, block vector, and the like using decoder-side intra mode derivation method.

In some aspects, a base intra angular mode and a first delta value can be signaled when the affine model (e.g., AIM model) is a 4-parameter model. Further, when a 6-parameter model is applied, a second delta value is further signaled in addition to the base intra angular mode and the first delta value.

In some aspects, the affine intra model (e.g., AIM model) can be applied at least one of sample-wise, subblock-wise, and the like. In some examples, N×N subblock level intra angular mode derivation is applied instead of sample-based intra angular mode derivation. The intra angular mode within each N×N subblock is derived based on the intra angular mode at one of the samples within the N×N subblock. N is a positive non-zero power of 2 integer value. For example, N can be 4. In some examples, the intra angular mode of an N×N subblock is derived from the intra angular mode at [N/2, N/2] of the N×N subblock (e.g., about the center position of the N×N subblock).

In some aspects, when the affine intra model (e.g., AIM model) is applied to the current block, line-based prediction can be utilized. In an example, when a first row of the current block is predicted, the prediction samples of the first row can be used as reference samples to predict the second row of the current block. In another example, when a first column of the current block is predicted, the prediction samples of the first column can be used as reference samples to predict the second column of the current block.

In some aspects, when derived intra mode by affine intra model (AIM model) is out of a conventional angular mode range, the derived intra mode can be clipped to the closest available angular mode. In an example, when the angular mode range is from −14 to 80, and a derived intra mode has an angle out of the angular mode range, the derived intra mode can be clipped to the intra mode −14 or the intra mode 80, depending on the angle.

In some aspects, the prediction signal by the affine intra model can be filtered using at least one of a position dependent filter, smoothing filter, sharpening filter, and the like.

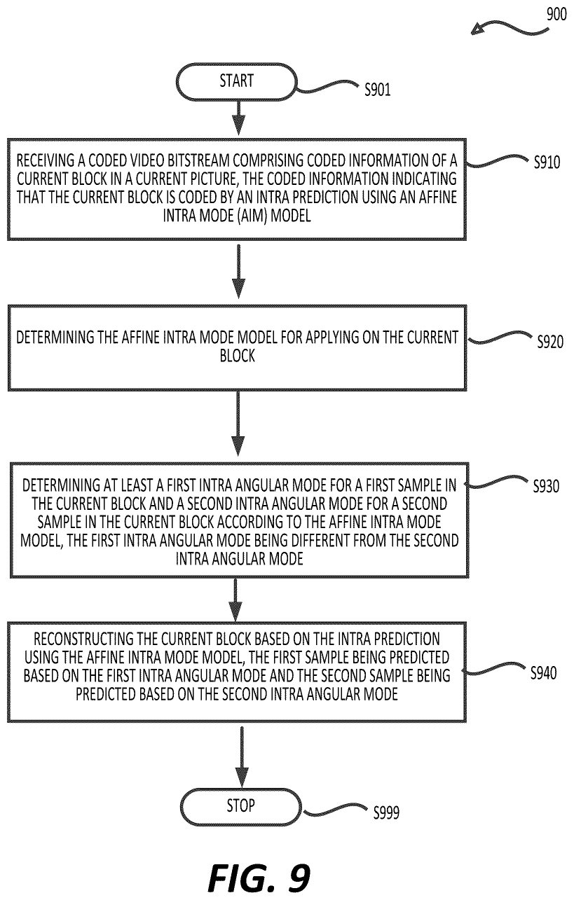

FIG. 9 shows a flow chart outlining a process (900) according to an aspect of the disclosure. The process (900) can be used in a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), a coded video bitstream is received. The coded video bitstream includes coded information of a current block in a current picture, the coded information indicates that the current block is coded by an intra prediction using an affine intra mode (AIM) model (also referred to as affine intra model in some examples).

At (S920), the affine intra mode model for applying on the current block is determined.

At (S930), at least a first intra angular mode for a first sample in the current block and a second intra angular mode for a second sample in the current block are determined according to the affine intra mode model, the first intra angular mode is different from the second intra angular mode.

At (S940), the current block is reconstructed based on the intra prediction using the affine intra mode model, the first sample is predicted based on the first intra angular mode and the second sample is predicted based on the second intra angular mode.

In some examples, the affine intra mode model is derived based on one or more intra angular modes associated with neighboring blocks of the current block. In some examples, the affine intra mode model is determined based on one or more syntaxes in the coded information of the current block.

In some aspects, the affine intra mode model is used to derive at least one of an angle, vectors associated with the angle, one or more trigonometric function value of the angle for a location in the current block.

In some aspects, the affine intra mode model is configured to derive an angle for a location in the current block, and an intra angular mode associated with the angle is determined according to a predefined angle table that maps angles to intra angular modes.

In some aspects, the coded information of the current block includes a flag that indicates whether the current block is coded using the affine intra mode model.

In some aspects, the affine intra mode model is derived based on two or more control point intra modes (CPIMs), a CPIM is an intra angular mode associated with a neighboring block of the current block in the current picture.

In some examples, a first CPIM associated with a first neighboring block and a second CPIM associated with a second neighboring block are available, the affine intra mode model is derived based on the first CPIM and the second CPIM.

In some examples, a first CPIM associated with a first neighboring block and a second CPIM associated with a second neighboring block are available, a third CPIM associated with a third neighboring block of the current block is derived based on the first CPIM and the second CPIM. Further, the affine intra mode model is derived based on the first CPIM, the second CPIM and the third CPIM.

In some examples, a first CPIM associated with a first neighboring block, a second CPIM associated with a second neighboring block and a third CPIM associated with a third neighboring block are available, the affine intra mode model is derived based on the first CPIM, the second CPIM and the third CPIM.

In some aspects, a plurality of CPIMs are available, a combination list is constructed from the plurality of CPIMs, the combination list includes combination candidates of CPIMs, a combination candidate is a combination of two or three CPIMs from the plurality of CPIMs. In some examples, a selected combination candidate is determined from the combination list based on an index that is signaled in the coded video bitstream. The affine intra mode model is derived based on the selected combination candidate.

In some aspects, the affine intra mode model is determined by a regression model using two or more intra angular modes associated with neighboring blocks of the current block.

In some aspects, a first intra mode associated with a first neighboring block of the current block is not an angular mode, the first intra mode is replaced with a second intra mode to be associated with the first neighboring block, the second intra mode is an angular mode, the second intra mode associated with the first neighboring block is one of the two or more CPIMs that are used to derive the affine intra mode model. In an example, the second intra mode is a default angular mode. In another example, the second intra mode is an angular mode that is derived by a decoder-side intra mode derivation from a template of the current block. In another example, the second intra mode is an angular mode that is derived by a decoder-side intra mode derivation from a reference block of the current block, the reference block is indicated by at least one of a block vector and/or a motion vector.

In some examples, the affine intra mode model is determined based on a base intra angular mode and a delta value when the affine intra mode model is a 4-parameter model, the base intra angular mode and the delta value are decoded from the coded video bitstream. In some examples, the affine intra mode model is determined based on a base intra angular mode, a first delta value and a second delta value when the affine intra mode model is a 6-parameter model, the base intra angular mode, the first delta value and the second delta value are decoded from the coded video bitstream.

In some examples, intra angular modes are determined in a sample-wise for samples in the current block according to the affine intra mode model. In some examples, intra angular modes are determined in a subblock-wise. For example, the first intra angular mode is determined for a first subblock of the current block that includes the first sample, and the second intra angular mode is determined for a second subblock of the current block that includes the second sample.

In some aspects, first predicted samples of a first line in the current block are generated; and second predicted samples of a second line in the current block are generated by using the first predicted samples as reference samples.

In some aspects, an angle-depending value for a sample in the current block is calculated, the angle-depending value indicates a prediction angle of the sample. When the prediction angle is out of an angle range of a set of intra angular modes, a specific intra angular mode is determined for the sample, the specific intra angular mode is a clipped intra angular mode in the set of intra angular modes that has a closest mapping angle to the prediction angle.

In some aspects, to reconstruct the current block, a prediction block of the current block is generated based on the affine intra mode model, the prediction block includes the first sample that is predicted based on the first intra angular mode and the second sample that is predicted based on the second intra angular mode. Further, at least one of a position dependent filter, a smooth filter and a sharpening filter is applied on the prediction block.

Then, the process proceeds to (S999) and terminates.

The process (900) can be suitably adapted. Step(s) in the process (900) can be modified and/or omitted. Additional step(s) can be added. Any suitable order of implementation can be used.

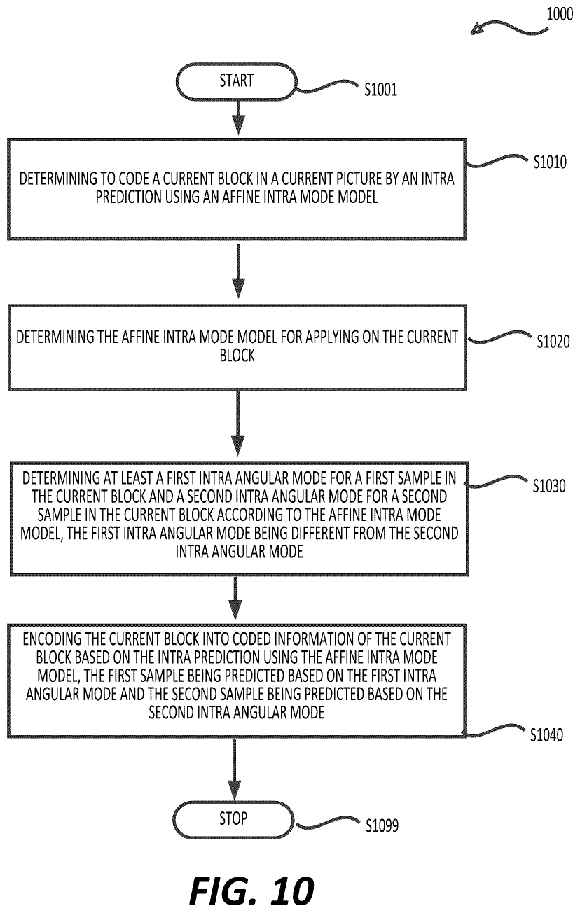

FIG. 10 shows a flow chart outlining a process (1000) according to an aspect of the disclosure. The process (1000) can be used in a video encoder. In various aspects, the process (1000) is executed by processing circuitry, such as the processing circuitry that performs functions of the video encoder (103), the processing circuitry that performs functions of the video encoder (303), and the like. In some aspects, the process (1000) is implemented in software instructions, thus when the processing circuitry executes the software instructions, the processing circuitry performs the process (1000). The process starts at (S1001) and proceeds to (S1010).

At (S1010), to code a current block in a current picture by an intra prediction using an affine intra mode model is determined.

At (S1020), the affine intra mode model for applying on the current block is determined.

At (S1030), at least a first intra angular mode for a first sample in the current block and a second intra angular mode for a second sample in the current block are determined according to the affine intra mode model, the first intra angular mode is different from the second intra angular mode.

At (S1040), the current block is encoded into coded information of the current block based on the intra prediction using the affine intra mode model, the first sample is predicted based on the first intra angular mode and the second sample is predicted based on the second intra angular mode.

In some examples, the affine intra mode model is derived based on one or more intra angular modes associated with neighboring blocks of the current block.

In some examples, one or more syntaxes are included into the coded information of the current block, the one or more syntaxes indicate the affine intra mode model.

In some examples, the affine intra mode model is used to derive at least one of an angle, vectors associated with the angle, one or more trigonometric function value of the angle for a location in the current block.

In some examples, the affine intra mode model is configured to derive an angle for a location in the current block, and an intra angular mode associated with the angle is determined according to a predefined angle table that maps angles to intra angular modes.

In some examples, a flag is included into the coded information of the current block, the flag indicates whether the current block is coded by using the affine intra mode model.

In some aspects, the affine intra mode model is derived based on two or more control point intra modes (CPIMs), a CPIM is an intra angular mode associated with a neighboring block of the current block in the current picture.

In some examples, a first CPIM associated with a first neighboring block and a second CPIM associated with a second neighboring block are available, the affine intra mode model is derived based on the first CPIM and the second CPIM.

In some examples, a first CPIM associated with a first neighboring block and a second CPIM associated with a second neighboring block are available, a third CPIM associated with a third neighboring block of the current block is derived based on the first CPIM and the second CPIM, and the affine intra mode model is derived based on the first CPIM, the second CPIM and the third CPIM.

In some examples, a first CPIM associated with a first neighboring block, a second CPIM associated with a second neighboring block and a third CPIM associated with a third neighboring block are available, the affine intra mode model is derived based on the first CPIM, the second CPIM and the third CPIM.

In some aspects, a plurality of CPIMs are available, a combination list is constructed from the plurality of CPIMs, the combination list includes combination candidates of CPIMs, a combination candidate is a combination of two or three CPIMs from the plurality of CPIMs. A selected combination candidate is determined from the combination list. The affine intra mode model is derived based on the selected combination candidate. A signal indicative of the selected combination candidate is included into the coded information of the current block.

In some aspects, the affine intra mode model is determined by a regression model using two or more intra angular modes associated with neighboring blocks of the current block.

In some examples, a first intra mode associated with a first neighboring block of the current block is not an angular mode. The first intra mode is replaced with a second intra mode to be associated with the first neighboring block, the second intra mode is an angular mode, the second intra mode associated with the first neighboring block is one of the two or more CPIMs that are used to derive the affine intra mode model. In an example, the second intra mode is a default angular mode. In another example, the second intra mode is an angular mode that is derived by a decoder-side intra mode derivation from a template of the current block. In another example, the second intra mode is an angular mode that is derived by a decoder-side intra mode derivation from a reference block of the current block, the reference block is indicated by at least one of a block vector and/or a motion vector.

In some examples, a base intra angular mode and a delta value are included into the coded information of the current block when the affine intra mode model is a 4-parameter model, the base intra angular mode and the delta value indicate the 4-parameter model (can be used to derive the affine intra mode model that is the 4-parameter model).

In some examples, a base intra angular mode, a first delta value and a second delta value are encoded into the coded information of the current block when the affine intra mode model is a 6-parameter model, the base intra angular mode, the first delta value and the second delta value indicate the 6-parameter model (can be used to derive the affine intra mode model that is the 6-parameter model).

In some examples, intra angular modes are determined in a sample-wise for samples in the current block according to the affine intra mode model.

In some examples, the first intra angular mode is determined for a first subblock of the current block that includes the first sample, and the second intra angular mode is determined for a second subblock of the current block that includes the second sample.

In some examples, first predicted samples of a first line in the current block are generated; and second predicted samples of a second line in the current block are generated by using the first predicted samples as reference samples.

In some examples, an angle-depending value for a sample in the current block is derived, the angle-depending value indicates a prediction angle of the sample. When the prediction angle is out of an angle range of a set of intra angular modes, a specific intra angular mode for the sample is determined, the specific intra angular mode is an intra angular mode (referred to as clipped intra angular mode) in the set of intra angular modes that has a closest mapping angle to the prediction angle.

In some examples, a prediction block of the current block is generated based on the affine intra mode model, the prediction block includes the first sample that is predicted based on the first intra angular mode and the second sample that is predicted based on the second intra angular mode. At least one of a position dependent filter, a smooth filter and a sharpening filter is applied on the prediction block.

Then, the process proceeds to (S1099) and terminates.

The process (1000) can be suitably adapted. Step(s) in the process (1000) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a current block in a current picture. The format rule specifies that the coded information indicates that the current block is coded by an intra prediction using an affine intra mode model. The format rule also specifies that the affine intra mode model for applying on the current block is determined; at least a first intra angular mode for a first sample in the current block and a second intra angular mode for a second sample in the current block are determined according to the affine intra mode model, the first intra angular mode being different from the second intra angular mode; and the current block is reconstructed based on the intra prediction using the affine intra mode model, the first sample being predicted based on the first intra angular mode and the second sample being predicted based on the second intra angular mode.

Some aspects of the disclosure provide techniques of online trained matrix intra prediction (OTMIP).

According to an aspect of the disclosure, in some related video codecs (e.g., VVC and ECM), intra prediction can be used to reduce the long-range correlations. Various intra prediction modes, such as angular modes, matrix based intra prediction (MIP) mode, the DIMD mode, template-based intra mode derivation (TIMD) mode and the like can be used in the related video codecs to perform better prediction.

In the angular modes, directional intra prediction are performed. The directional intra prediction can predict the values of a block of pixels by extrapolating from the values of adjacent pixels, such as using simple linear or angular models.

In some related examples, matrix based intra prediction (MIP) uses pretrained filters and performs matrix multiplication on the reference pixels to generate prediction blocks. The MIP employs a more sophisticated approach than the angular modes. The MIP can use a predefined matrix to transform reference samples (e.g., neighboring reconstructed pixels of the current block) into predicted values for the current block (e.g., a matrix multiplication of the reference samples with the predefined matrix to generate the predicted sample values of the current block). The matrix operation can capture more complex spatial relationships and patterns than the directional intra prediction.

In some related examples, in an extrapolation-based intra prediction (EIP) mode, the filters can be learnt from an auto-correlation matrix and the cross-correlation matrix derived from the neighboring reconstructed blocks or inherit from the neighboring EIP blocks. The filter can be used to predict one pixel at a time and can be recursively used to predict pixel by pixel until the entire block is filled.

Some aspects of the disclosure provide technique of online trained matrix intra prediction mode to derive the MIP matrix online rather than use the pre-trained matrixes to generate the prediction block. Better adaptiveness can be achieved by the online training which utilizes the benefit of overfitting.

In some aspects, a reference region with multiple reference lines (e.g., rows, columns and the like) exists for a coding block, the MIP matrix can be derived from the reference region by setting some reference line(s) as a reference, such as one or more reference lines as the reference, and setting the others (one or more other reference line(s)) as a target for the derivation of the MIP matrix.

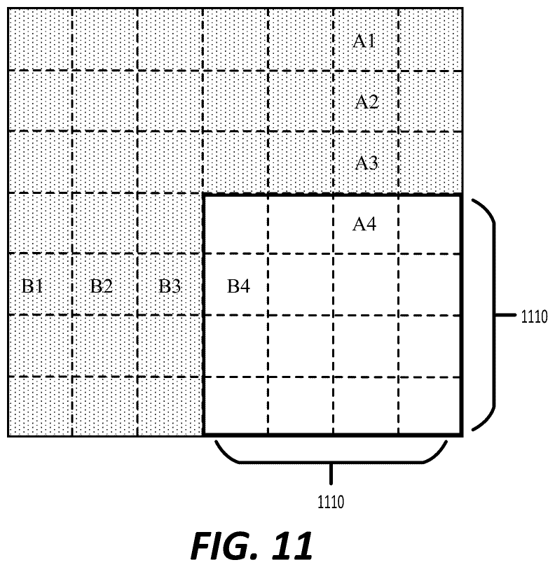

FIG. 11 shows a diagram of a current block (1110) with multiple reference lines in some examples.

In FIG. 11, a reference region (e.g., show as dark portion in FIG. 11) of the current block (1110) is available, the reference region includes 3 reference rows {A1, A2, A3} and 3 reference columns {B1, B2, B3} available. In an example, the topRow A1 and the leftColumn B1 are used as features (e.g., an L shaped reference line) and regions of {A1, A2, B1, B2} are used as target (e.g., two L shaped reference lines) for an online training to derive the matrix (e.g., MIP matrix) for a prediction of the current block.

In some examples, the matrix (e.g., MIP matrix of online training) can be trained using the same way (e.g., same procedures, same algorithms, and the like) as the training of MIP matrixes in some related examples (e.g., same procedures, same algorithms that are applied on training samples in the pretraining to obtain the pre-trained matrixes). In some examples, the matrix can be trained using any suitable machine learning, regression algorithms, optimization systems, and the like.

In some examples, the matrix can be trained using samples from one direction (vertical/horizonal). For example, a matrix can be trained using reconstructed samples in a reference row in an example. In another example, a matrix can be trained using reconstructed samples in a reference column.

In some aspects, multiple matrixes can be trained, and the final prediction can be as weighted combination of predictions from the multiple matrixes.

In some examples, horizonal online trained MIP prediction can be used. In the FIG. 11 example, a first matrix m₁ can be derived by using {A1} as reference and using {A2, A3} as target; a second matrix m₂ can be derived using data pair (reference, target) {(A1,A2), (A2,A3)} (e.g., by a first set of data pair using A1 as reference and A2 as target, and a second set of data pair using A2 as reference and A3 as target).

For example, using matrix m₁ and reference A2 to make the prediction, two predicted rows are derived, such as a predicted row m1_A3_p2 (e.g., m1 indicates that the matrix is m₁, A3 indicates that the location of the predicted row is at A3, p2 indicates that the location of the reference is at A2) and a predicted row m1_A4_p2 ((e.g., m1 indicates that the matrix is m₁, A4 indicates that the location of predicted row is at A4, p2 indicates that location of the reference is at A2).

In the example, using matrix m₁ and reference A3 to make the prediction, two predicted rows are derived, such as a predicted row m1_A4_p3 ((e.g., m1 indicates that the matrix is m₁, A4 indicates that the location of the predicted row is at A4, p3 indicates that the location of the reference is at A3) and a predicted row m1_A5_p3 (e.g., m1 indicates that the matrix is m₁, A5 indicates that the location of the predicted row is at A5, p3 indicates that the location of the reference is at A3).

In the example, using matrix m₂ and reference A2 to make the prediction, one predicted row is derived, such as a predicted row m2_A3_p2 (e.g., m2 indicates that the matrix is m₂, A3 indicates that the location of the predicted row is at A3, p2 indicates that the location of the reference is at A2).

In the example, using matrix m₂ and reference A3 to make the prediction, one predicted row is derived, such as denoted by a predicted row m2_A4_p3 (e.g., m2 indicates that the matrix is m₂, A4 indicates that the location of the predicted row is at A4, p3 indicates that the location of the reference is at A3).

Further, in the example, then the predicted rows for the reference row A3, such as the predicted rows m1_A3_p2 and m2_A3_p2, and the reference row A3 itself can be used as auto correction and (or) to calculate the combination weight values, such as a weight value w, when combining the predictions from two matrixes m₁ and m₂.

In an example, the final prediction for row A4 can be derived using a weighted sum, such as using formular m2_A4_p3+w×m1_A4_p3. In another example, the final prediction for row A4 can be derived using a weighted sum, such as using formular (1−w)×m2_A4_p3+w×m1_A4_p3.

It is noted that more predictions can be added to the weighted sum when there are 3 or more prediction matrixes available.

In some aspects, when the number of reference lines is more than the height/width of the prediction block (e.g., current coding block), one single matrix can be derived to make the prediction. For example, the single matrix is derived based on setting a portion of reference lines of the size of the current coding block as target, and the single matrix is used to derive a prediction of the current coding block. For example, a single matrix multiplication of reference lines with the single matrix can generate all the prediction samples of the current coding block in an example.

In some aspects, when the number of reference lines is less than the height/width of the prediction block, recursive prediction can be used applied. In some examples, when the matrix can predict two lines each time, then it may use the prediction lines as reference to make new predictions recursively until the entire prediction block (current coding block) is filled.

In some aspects, when the number of reference line is less than the height/width of the prediction block, then recursive training and prediction can be applied. In some examples, the matrix can be re-trained after a prediction using previous training data and the new data derived from the last prediction. For example, after prediction of row A4 based on m₂ and the reference row A3, a new training data pair (A3, m2_A4_p3) can be included in the training data and m₂ can be retrained. The re-trained m₂ can be used to predict, for example, a row below A4 based on m2_A4_p3.

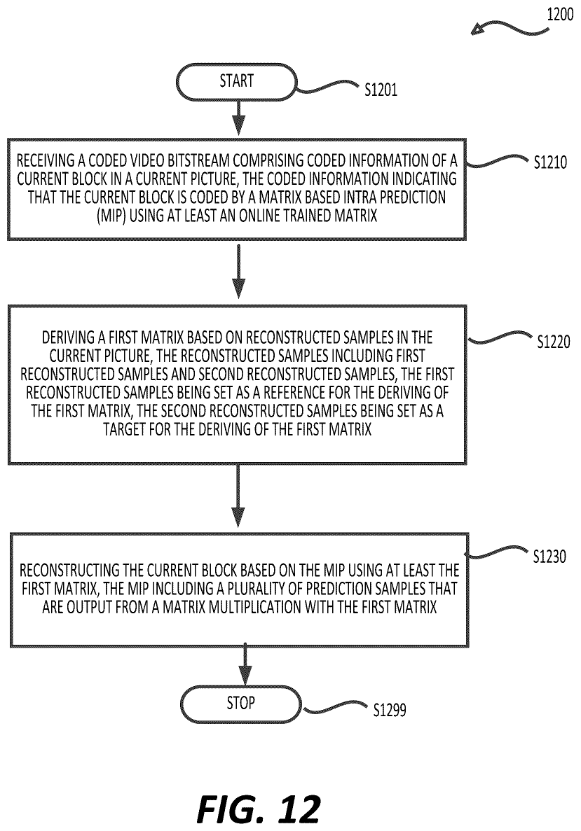

FIG. 12 shows a flow chart outlining a process (1200) according to an aspect of the disclosure. The process (1200) can be used in a video decoder. In various aspects, the process (1200) is executed by processing circuitry, such as the processing circuitry that performs functions of the video decoder (110), the processing circuitry that performs functions of the video decoder (210), and the like. In some aspects, the process (1200) is implemented in software instructions, thus when the processing circuitry executes the software instructions, the processing circuitry performs the process (1200). The process starts at (S1201) and proceeds to (S1210).

At (S1210), a coded video bitstream is received. The coded video bitstream includes coded information of a current block in a current picture, the coded information indicates that the current block is coded by a matrix based intra prediction (MIP) using at least an online trained matrix.

At (S1220), a first matrix is derived based on reconstructed samples in the current picture, the reconstructed samples includes first reconstructed samples and second reconstructed samples, the first reconstructed samples are set as a reference for the deriving of the first matrix, the second reconstructed samples are set as a target for the deriving of the first matrix

At (S1230), the current block is reconstructed based on the MIP using at least the first matrix, the MIP includes a plurality of prediction samples that are output from a matrix multiplication with the first matrix.

In some aspects, the reconstructed samples are in the form of reference lines, the first reconstructed samples are in in a first reference line in the reference lines, the second reconstructed samples are in one or more second reference lines in the reference lines.

In an example, the first reference line and the one or more second reference lines are L-shaped lines. In another example, the first reference line and the one or more second reference lines are vertical lines. In another example, the first reference line and the one or more second reference lines are horizontal lines.

In some aspects, the first matrix is derived based on at least one of a regression algorithm, a machine learning algorithm, and an optimization system.

In some aspects, a second matrix is derived based on the reconstructed samples in the current picture. A plurality of first prediction samples are generated from a first matrix multiplication with the first matrix, the plurality of first prediction samples include a first prediction for a sample in the current block. A plurality of second prediction samples are generated from a second matrix multiplication with the second matrix, the plurality of second prediction samples include a second prediction for the sample in the current block. A weighted sum of at least the first prediction and the second prediction is calculated to be a matrix based intra prediction of the sample in the current block.

In some examples, one or more weight values are calculated based on the reconstructed samples in the current picture.

In some examples, a counting number of the reference lines is larger than at least one of a height or a width of the current block. A matrix based intra prediction block of the current block is generated from a single matrix multiplication with the first matrix.

In some examples, a counting number of the reference lines is less than both a height and a width of the current block. First matrix based intra prediction samples are generated from a first matrix multiplication with the first matrix, the first matrix based intra prediction samples are a first portion of the current block. Second matrix based intra prediction samples are generated from a second matrix multiplication with the first matrix using one or more of the first matrix based intra prediction samples as a reference, the second matrix based intra prediction samples are a second portion of the current block that includes at least a non-overlapping sample with the first portion.

In some examples, a counting number of the reference lines is less than both a height and a width of the current block. First matrix based intra prediction samples are generated from a first matrix multiplication with the first matrix, the first matrix based intra prediction samples are a first portion of the current block. A second matrix is derived based on the reconstructed samples and at least one prediction sample in the first matrix based intra prediction samples. Second matrix based intra prediction samples are generated from a second matrix multiplication with the second matrix using one or more of the first matrix based intra prediction samples as a reference, the second matrix based intra prediction samples are a second portion of the current block that includes at least a non-overlapping sample with the first portion. Then, the process proceeds to (S1299) and terminates.

The process (1200) can be suitably adapted. Step(s) in the process (1200) can be modified and/or omitted. Additional step(s) can be added. Any suitable order of implementation can be used.

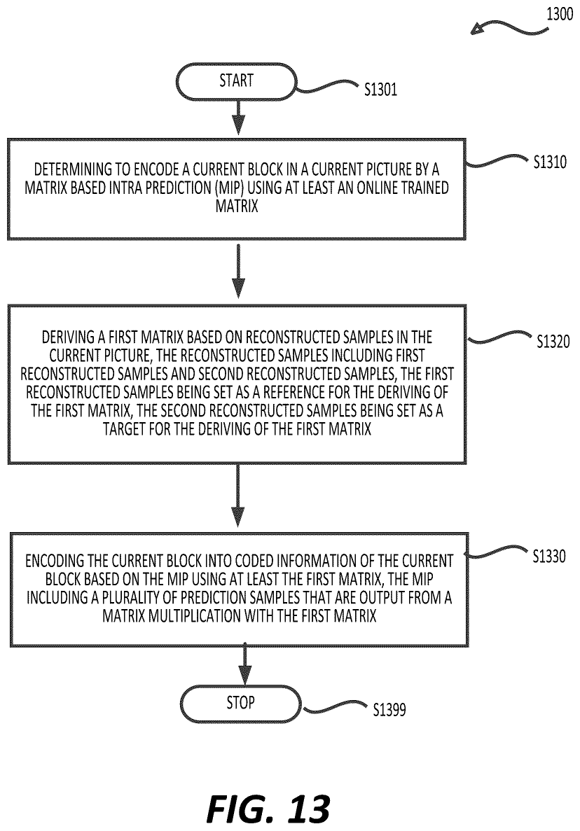

FIG. 13 shows a flow chart outlining a process (1300) according to an aspect of the disclosure. The process (1300) can be used in a video encoder. In various aspects, the process (1300) is executed by processing circuitry, such as the processing circuitry that performs functions of the video encoder (103), the processing circuitry that performs functions of the video encoder (303), and the like. In some aspects, the process (1300) is implemented in software instructions, thus when the processing circuitry executes the software instructions, the processing circuitry performs the process (1300). The process starts at (S1301) and proceeds to (S1310).

At (S1310), to encode a current block in a current picture by a matrix based intra prediction (MIP) using at least an online trained matrix is determined.

At (S1320), a first matrix is derived based on reconstructed samples in the current picture, the reconstructed samples includes first reconstructed samples and second reconstructed samples, the first reconstructed samples are set as a reference for the deriving of the first matrix, the second reconstructed samples are set as a target for the deriving of the first matrix.

At (S1330), the current block is encoded into coded information of the current block based on the MIP using at least the first matrix, the MIP includes a plurality of prediction samples that are output from a matrix multiplication with the first matrix.

In some aspects, the reconstructed samples are in reference lines, the first reconstructed samples are in in a first reference line in the reference lines, the second reconstructed samples are in one or more second reference lines in the reference lines.

In an example, the first reference line and the one or more second reference lines are L-shaped lines. In another example, the first reference line and the one or more second reference lines are vertical lines. In another example, the first reference line and the one or more second reference lines are horizontal lines.

In some aspects, the first matrix is derived based on at least one of a regression algorithm, a machine learning algorithm, and an optimization system.

In some aspects, a second matrix is derived based on the reconstructed samples in the current picture. A plurality of first prediction samples are generated from a first matrix multiplication with the first matrix, the plurality of first prediction samples include a first prediction for a sample in the current block. A plurality of second prediction samples are generated from a second matrix multiplication with the second matrix, the plurality of second prediction samples include a second prediction for the sample in the current block. A weighted sum of at least the first prediction and the second prediction is calculated to be a matrix based intra prediction of the sample in the current block.

In some examples, one or more weight values are calculated based on the reconstructed samples in the current picture.

In some examples, a counting number of the reference lines is larger than at least one of a height or a width of the current block. A matrix based intra prediction block of the current block is generated from a single matrix multiplication with the first matrix.

In some examples, a counting number of the reference lines is less than both a height and a width of the current block. First matrix based intra prediction samples are generated from a first matrix multiplication with the first matrix, the first matrix based intra prediction samples are a first portion of the current block. Second matrix based intra prediction samples are generated from a second matrix multiplication with the first matrix using one or more of the first matrix based intra prediction samples as a reference, the second matrix based intra prediction samples are a second portion of the current block that includes at least a non-overlapping sample with the first portion.

In some examples, a counting number of the reference lines is less than both a height and a width of the current block. First matrix based intra prediction samples are generated from a first matrix multiplication with the first matrix, the first matrix based intra prediction samples are a first portion of the current block. A second matrix is derived based on the reconstructed samples and at least one prediction sample in the first matrix based intra prediction samples. Second matrix based intra prediction samples are generated from a second matrix multiplication with the second matrix using one or more of the first matrix based intra prediction samples as a reference, the second matrix based intra prediction samples are a second portion of the current block that includes at least a non-overlapping sample with the first portion.

Then, the process proceeds to (S1399) and terminates.

The process (1300) can be suitably adapted. Step(s) in the process (1300) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a plurality of pictures. The format rule specifies that the coded information indicates that the current block is coded by a matrix based intra prediction (MIP) using at least an online trained matrix. The format rule also specifies that a first matrix is derived based on reconstructed samples in the current picture, the reconstructed samples including first reconstructed samples and second reconstructed samples, the first reconstructed samples being set as a reference for the deriving of the first matrix, the second reconstructed samples being set as a target for the deriving of the first matrix; and the current block is reconstructed based on the MIP using at least the first matrix, the MIP including a plurality of prediction samples that are output from a matrix multiplication with the first matrix.

Some aspects of the disclosure provide techniques of generalized linear angle prediction. The techniques can provide more flexibility to the angle intra prediction method.

In some related video coding standards, the angle intra prediction method is used to predict directional patterns. In some related examples, the angle prediction has one parameter (known as prediction angle), which can be denoted by w.

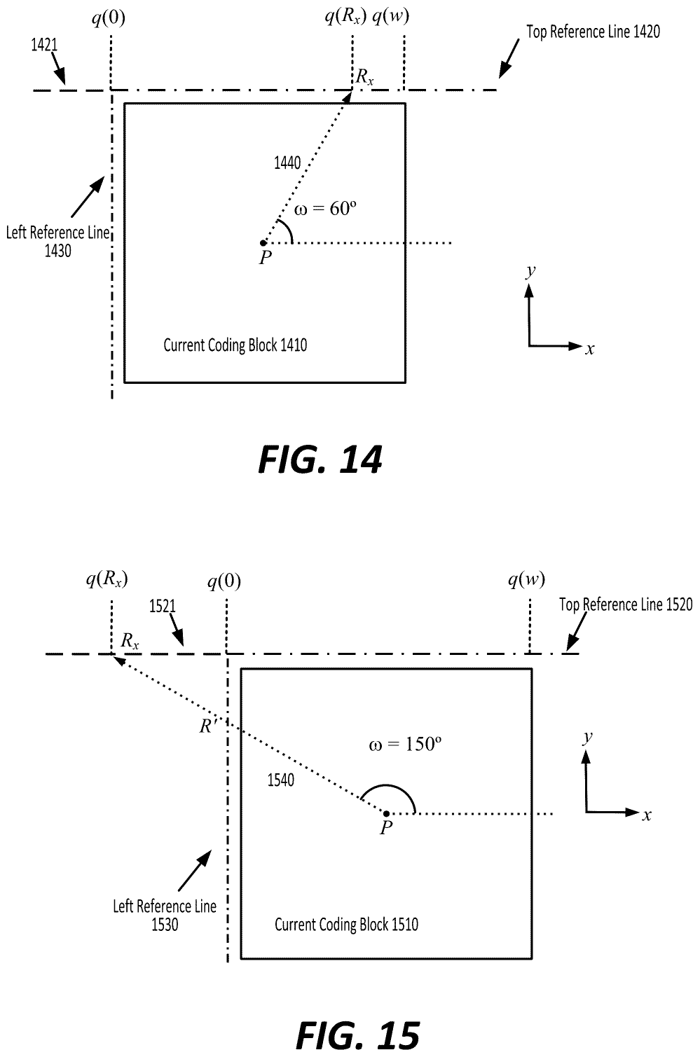

FIG. 14 shows a diagram of angle prediction in some examples. In the FIG. 14 example, a current coding block (1410) has a top reference line (1420) of reference samples on top of the current coding block (1410), and has a left reference line (1430) of reference samples to the left of the current coding block (1410).

In the FIG. 14 example, given a pixel location P (x₀, y₀) and a prediction angle ω, the predicted sample value can be acquired by drawing a line (1440) with x-axis angle ω, and determining its x-coordinate of its intersection (denoted by Rₓ) with the top reference line (1420). The pixel value at Rₓ (denoted by q(Rₓ)) on the top reference line (1420) is used as the predicted sample value for p(x₀, y₀), such as represented by Eq. (12) and Eq. (13):

$${R}_{x} = {x}_{0} - \frac{{y}_{0}}{tan ω} \qquad Eq . ( 12 )$$

$$p ( {x}_{0} , {y}_{0} ) = q ( {R}_{x} ) \qquad Eq . ( 13 )$$

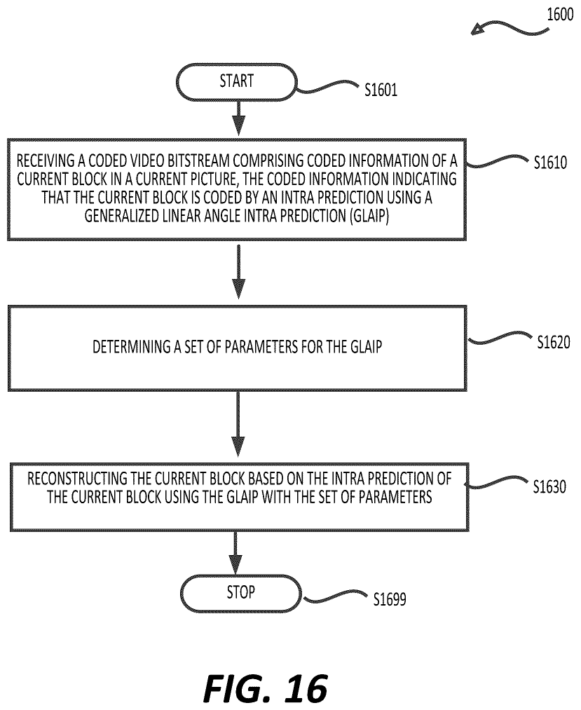

FIG. 15 shows another diagram of angle prediction in some examples. In the FIG. 15 example, a current coding block (1510) has a top reference line (1520) of reference samples on top of the current coding block (1510), and has a left reference line (1530) of reference samples to the left of the current coding block (1510).

In the FIG. 15 example, when Rₓ<0, the predicted sample value for p(x₀, y₀) can be acquired from the left reference line (1530) instead of the top reference line (1520). In some examples, by basic trigonometry, the coordinates on the top reference line (1520) are scaled by tan ω compared to the left reference line (1530). Without loss of generality, the scaling can be applied to the pixels on the left reference line (1530) and place them on the top reference line (1520). Using the scaling technique, one reference line (e.g., the top reference line (1520) is used, and the Eq. (12) can be applied to all possible values of Rₓ in some examples.

Some aspects of the disclosure provide techniques of generalized linear angle intra prediction (GLAIP). For example, in GLAIP, Eq. (11) can be extended to Eq. (13):

$${R}_{{x}_{i}} = {\sum }_{m} {\sum }_{n} {α}_{m , n} {x}_{i}^{m} {y}_{i}^{n} \qquad Eq . ( 13 )$$

It is noted that Eq. (11) is a special case of Eq. (13) where the set of m, n is given by {(m, n)}={(0,1), (1,0)}.

In some examples, for angular (also related as traditional angular in related examples), the set of m, n can be set as {(m, n)}={(0,1), (1,0)}. In some examples, for angular with translation based prediction, the set of m, n can be set as {(m, n)}={(0,1), (1,0), (0,0)}. In some examples, for quadratic based prediction, the set of m, n can be set as {(m, n)}={(2,0), (0,2), (1,1), (0,1), (1,0), (0,0)}.

In some examples, to derive GLAIP parameters α_{m,n}, two methods can be used.

In the first method (also referred to as linear model based derivation), the reference line can be modeled using a linear model, such as using Eq. (14):

$$q ( x ) = kx + b \qquad Eq . ( 14 )$$

In some examples, o(xᵢ, yᵢ) denotes the target pixel at (xᵢ, yᵢ). Depending on the usage of the first method, the target pixel can be acquired from original pixels or reconstruction pixels. The optimization objective is to minimize Eq. (15):

$${( p ( {x}_{i} , {y}_{i} ) - o ( {x}_{i} , {y}_{i} ) )}^{2} = {( q ( {R}_{{x}_{i}} ) - o ( {x}_{i} , {y}_{i} ) )}^{2} \qquad Eq . ( 15 )$$

In some examples, the optimization problem is written as a linear least squares system to solve for α_{m,n}, such as using Eq. (16):

$$[ \begin{matrix}1 & {ky}_{1} & ⋯ & {kx}_{1} & ⋯ \\ 1 & {ky}_{2} & ⋯ & {kx}_{2} & ⋯ \\ ⋮ & ⋮ & ⋱ & ⋮ & ⋱\end{matrix} ] [ \begin{matrix}{α}_{0 , 0} \\ {a}_{0 , 1} \\ ⋮ \\ {α}_{1 , 0} \\ ⋮\end{matrix} ] = [ \begin{matrix}o ( {x}_{0} , {y}_{0} ) \\ o ( {x}_{1} , {y}_{1} ) \\ ⋮\end{matrix} ] \qquad Eq . ( 16 )$$

In the second method (also referred to as non-linear least square based derivation), the linear reference line assumption is not used. In some examples, non-linear least squares methods are used to solve for α_{m,n}. For example, the Levenberg-Marquardt (LM) algorithm can be used to solve for GLAIP parameters. In LM algorithm, the Jacobian parameters can be calculated for the least squares system, such as using Eq. (17):

$${J}_{i , m , n} = \frac{\partial q ( {R}_{x} )}{\partial {α}_{m , n}} {\vert}_{x = {x}_{i}} = \frac{\partial q ( {R}_{x} )}{\partial {R}_{x}} {\vert}_{x = {x}_{i}} \cdot \frac{\partial {R}_{x}}{\partial {α}_{m , n}} {\vert}_{x = {x}_{i}} \qquad Eq . ( 17 )$$

In some examples, the Jacobian parameters can be used to compute a vector Aa to iteratively update the GLAIP parameters, such as using Eq. (18):

$$[ \begin{matrix}{α}_{0 , 0}^{( k + 1 )} \\ {a}_{0 , 1}^{( k + 1 )} \\ ⋮ \\ {α}_{1 , 0}^{( k + 1 )} \\ ⋮\end{matrix} ] = [ \begin{matrix}{α}_{0 , 0}^{( k )} \\ {a}_{0 , 1}^{( k )} \\ ⋮ \\ {α}_{1 , 0}^{( k )} \\ ⋮\end{matrix} ] + [ \begin{matrix}{Δα}_{0 , 0} \\ Δ {a}_{0 , 1} \\ ⋮ \\ {Δα}_{1 , 0} \\ ⋮\end{matrix} ] \qquad Eq . ( 18 )$$

In some examples, since the gradient of the reference line

$$\frac{\partial q ( {R}_{x} )}{\partial {R}_{x}}$$

is required in Eq. (17), the reference line can be interpolated (e.g., using linear, quadratic, or cubic spline interpolation).

It is noted that in the construction of the top reference line, some portions (e.g., shown by (1421) in FIGS. 14 and (1521) in FIG. 15) of the top reference line (e.g., the top reference line (1420) in FIG. 14 and the top reference line (1520) in FIG. 15) can be re-scaled based on w. As a result, the predicted signal generated by GLAIP also depends on the choice of w.

In some aspects, when GLAIP is used for the current coding block, the parameters α_{m,n} are completely derived from the template area of the current coding block. For example, the GLAIP parameters are derived from the reconstruction pixels in the template and the reference line of the template. No GLAIP parameters are signaled in the bitstream. In some examples, the template area of the current block includes first reconstructed samples of a template of the current block, and second reconstructed samples of a reference line of the template. For example, the template area of the current block includes three rows above the current block, the bottom two rows of the three rows can be a template of the current block, and the upper row in the three rows can be a reference line of the template. In another example, the template area of the current block includes three columns left to the current block, the two columns closer to the current block can be a template of the current block, and the farthest column in the three columns can be a reference line of the template. In some examples, the template can include L shaped template, and the reference line can be an L shaped reference line.

In some examples, the set of GLAIP parameters α_{m,n} are given by the angular with translation set mentioned above.

In some examples, the set of GLAIP parameters α_{m,n} are given by the quadratic set mentioned above.

In some examples, the parameter derivation method is the first derivation method (e.g., the linear model based derivation).

In some examples, the parameter derivation method is the second derivation method (non-linear least square based derivation).

In some examples, the parameter ω (also referred to as prediction angle and is associated with the intra prediction mode) is based on the derived decoder side intra mode derivation (DIMD) mode of the current coding block. In DIMD, the intra prediction mode for the current block is not explicitly signaled in the bitstream. Instead, the decoder derives the intra mode based on the reconstructed neighboring pixels or blocks.

In some examples, the parameter ω is based on the derived occurrence based intra mode coding (OBIC) mode of the current coding block. In the OBIC mode, the selection and coding of intra prediction mode of the current block are influenced by the frequency (occurrence) of each intra mode within a coded neighboring region of the current block.

In some examples, the parameter ω is determine by RD optimization and signaled.

In some examples, the top template (e.g., top rows) of the current coding block is used to derive α_{m,n}. The reference line of the top template is used to predict the reconstruction pixels of the top template. The parameter derivation method is used to find the best GLAIP parameters that minimizes the distance between the GLAIP prediction and the reconstruction pixels.

In some examples, the left template (e.g., left columns) of the current coding block is used to derive α_{m,n}. The reference line of the left template is used to predict the reconstruction pixels of the top template. The parameter derivation method is used to find the best GLAIP parameters that minimizes the distance between the GLAIP prediction and the reconstruction pixels.

In some examples, both top and left templates (e.g., L shaped template) are used to derive GLAIP parameters.

In some aspects, when GLAIP is used for the current coding block, the parameters α_{m,n} are derived using the current coding block area (by the encoder), and the derived parameters are signaled. In some examples, the reference line of the current coding block is used to predict the original pixels of the current coding block. The parameter derivation method is used to find the best GLAIP parameters that minimizes the distance between the GLAIP prediction and the original pixels. The derived GLAIP parameters are signaled in the bitstream.

In some examples, the set of GLAIP parameters α_{m,n} are given by the traditional angular with translation set.

In some examples, the set of GLAIP parameters α_{m,n} are given by the quadratic set.

In some examples, the parameter derivation method is the first derivation method (e.g., the linear model based derivation).

In some examples, the parameter derivation method is the second derivation method (non-linear least square based derivation).

In some examples, the parameter ω is based on the derived Decoder Side Intra Mode Derivation (DIMD) mode of the current coding block.

In some examples, the parameter ω is based on the derived Occurrence Based Intra Mode Coding (OBIC) mode of the current coding block.

In some examples, the parameter ω is determine by rate-distortion (RD) optimization and signaled from the encoder side to the decoder side.

In some aspects, when GLAIP is used for the current coding block, the parameters α_{m,n} are split into two sets: {α_{derive}} and {α_{signal}}. The parameters in {α_{signal}} are signaled in the bitstream, and the parameters in {α_{derive}} are derived using the template.

In some examples, the partition of {α_{derive}} and {α_{signal}} is signaled in the bitstream.

In some examples, {α_{signal}} includes a fixed number (denoted by W) of parameters. For example, W of the parameters are signaled in the bitstream. The mapping from signaled parameters and α_{m,n} can be derived by analyzing the template area in an example.

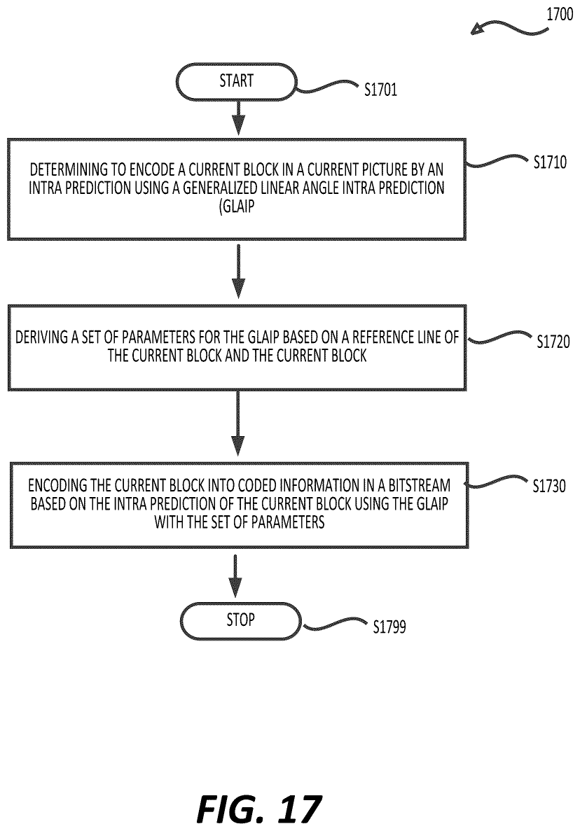

FIG. 16 shows a flow chart outlining a process (1600) according to an aspect of the disclosure. The process (1600) can be used in a video decoder. In various aspects, the process (1600) is executed by processing circuitry, such as the processing circuitry that performs functions of the video decoder (110), the processing circuitry that performs functions of the video decoder (210), and the like. In some aspects, the process (1600) is implemented in software instructions, thus when the processing circuitry executes the software instructions, the processing circuitry performs the process (1600). The process starts at (S1601) and proceeds to (S1610).

At (S1610), a coded video bitstream is received. The coded video bitstream includes coded information of a current block in a current picture, the coded information indicates that the current block is coded by an intra prediction using a generalized linear angle intra prediction (GLAIP).

At (S1620), a set of parameters for the GLAIP is determined.

At (S1630), the current block is reconstructed based on the intra prediction of the current block using the GLAIP with the set of parameters.

In some aspects, the set of parameters is derived based on first reconstructed samples in a template of the current block and second reconstructed samples in a reference line of the template.

In an example, the set of parameters is a set of angular with translation parameters. In another example, the set of parameters is a set of quadratic parameters.

In some examples, the set of parameters is derived using a linear model based derivation. In some examples, the set of parameters is derived using a non-linear least square based derivation.

In some examples, a prediction angle is determined based on a derived decoder side intra mode derivation (DIMD) mode of the current block. In some examples, the prediction angle is derived based on derived occurrence based intra mode coding (OBIC) derivation. In some examples, the prediction angle is decoded from the coded video bitstream.

In some examples, the template of the current block includes one or more rows above the current block, the reference line includes a row above the template. In some examples, the template of the current block includes one or more columns left to the current block, the reference line includes a column left to the template. In some examples, the template and the reference line of the template can have L shapes.

In some examples, prediction samples for the first reconstructed samples are generated based on the reference line by the intra prediction using the GLAIP. A difference measure (e.g., distance) between the prediction samples and the first reconstructed samples is calculated. The set of parameters is derived to minimize the difference measure.

In some examples, the set of parameters for the GLAIP is determined according to one or more syntaxes in the coded information of the current block.

In some examples, a first subset of the set of parameters for the GLAIP is determined according to one or more syntaxes in the coded information of the current block; and a second subset of the set of parameters is determined based on first reconstructed samples in a template of the current block, second reconstructed samples in a reference line of the template, and the first subset of the set of parameters. In an example, a syntax that indicates a partition of the set of parameters into the first subset and the second subset can be decoded from the coded video bitstream. In some examples, the first subset includes a fixed number of parameters.

Then, the process proceeds to (S1699) and terminates.

The process (1600) can be suitably adapted. Step(s) in the process (1600) can be modified and/or omitted. Additional step(s) can be added. Any suitable order of implementation can be used.

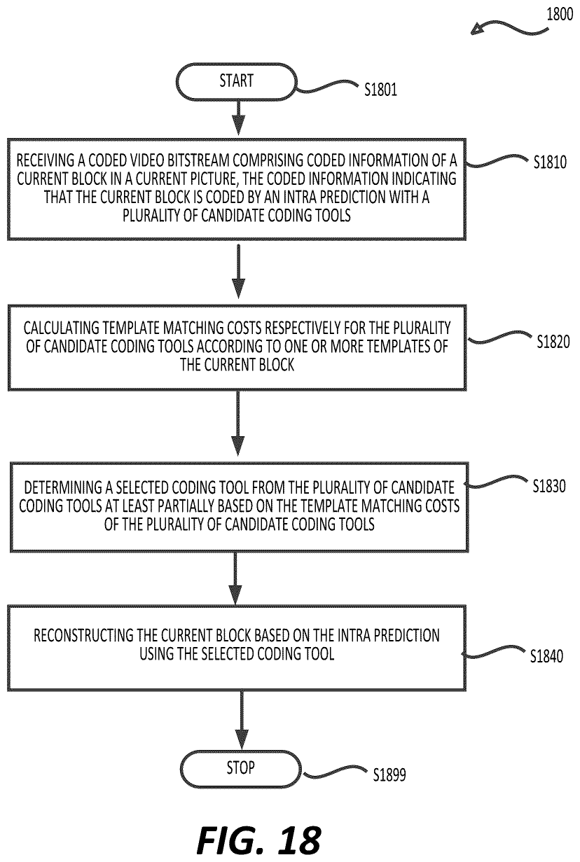

FIG. 17 shows a flow chart outlining a process (1700) according to an aspect of the disclosure. The process (1700) can be used in a video encoder. In various aspects, the process (1700) is executed by processing circuitry, such as the processing circuitry that performs functions of the video encoder (103), the processing circuitry that performs functions of the video encoder (303), and the like. In some aspects, the process (1700) is implemented in software instructions, thus when the processing circuitry executes the software instructions, the processing circuitry performs the process (1700). The process starts at (S1701) and proceeds to (S1710).

At (S1710), to encode a current block in a current picture by an intra prediction using a generalized linear angle intra prediction (GLAIP) is determined.

At (S1720), a set of parameters for the GLAIP is derived based on a reference line of the current block and the current block.

At (S1730), the current block is encoded into coded information in a bitstream based on the intra prediction of the current block using the GLAIP with the set of parameters.

In some aspects, prediction samples for the current block are generated based on the reference line by the intra prediction using the GLAIP. A difference measure (e.g., a distance) between the prediction samples and original samples in the current block is calculated. The set of parameters is derived to minimize the difference measure.

In some examples, one or more syntax elements that indicate the set of parameters are included into the coded information in the bitstream.

In an example, the set of parameters is a set of angular with translation parameters. In another example, the set of parameters is a set of quadratic parameters.

In some examples, the set of parameters is derived using a linear model based derivation. In some examples, the set of parameters is derived using a non-linear least square based derivation.

In some examples, a prediction angle is determined based on a derived decoder side intra mode derivation (DIMD) mode of the current block. In some examples, the prediction angle is derived based on derived occurrence based intra mode coding (OBIC) derivation.

In some examples, a prediction angle is derived based on a rate-distortion optimization, and a syntax element is included in the coded information of the current block, the syntax element indicates the prediction angle.

Then, the process proceeds to (S1799) and terminates.

The process (1700) can be suitably adapted. Step(s) in the process (1700) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream includes coded information of a current block in a current picture, the coded information indicates that the current block is coded by an intra prediction using a generalized linear angle intra prediction (GLAIP). The format rule specifies that a set of parameters for the GLAIP is determined, and the current block is reconstructed based on the intra prediction of the current block using the GLAIP with the set of parameters.

Some aspects of the disclosure provide technique of mode/tool selection for intra prediction based on template matching cost.

Some image and video coding standards can use a hybrid framework. A hybrid video coding framework can include various modules, such as intra prediction, inter prediction, transform, quantization, in-loop filter and the like.

In some related video codecs such as ECM, template-based intra mode derivation (TIMD) mode uses template matching to derive the intra prediction model that minimize the TM cost.

Some aspects of the disclosure provide techniques to use template matching cost to derive the coding tool/modes implicitly. In the template area of a coding block, both reconstruction and the reference data are available. Then, different processing methods (e.g., coding modes, coding tools and the like), such as filtering, enhancing, compensation and the like, can be applied on the template and to determine the best procedure that can minimize the template matching cost.

In some aspects, template matching cost can be used to determine reference samples filters. In some examples, the reference sample filters can be respectively used on a template region to derive respective template results associate with the reference sample filters. The template results associated with the reference sample filters can be compared with the template to calculate respective cost values (also referred to as template matching cost values) associated with the reference sample filters.

In some examples, template matching cost can be used to determine reference samples interpolation filters for any intra prediction mode that allow multiple interpolation filter options. It is noted that no additional limitations are put to the applicability of this method in some examples. For example, the template matching approach is used to determine the interpolation filter even when a conventional (non template matching based) method is used to select the intra prediction mode.

In an example, when intra prediction mode is selected to be an angular mode, the template matching method is used to determine the interpolation filter among some predefined set of possible filters by selecting the one that gives minimal cost on the template.

In some examples, template matching cost can be used to determine reference samples filters that is applied prior to intra prediction process.

In an example, a flag is signalled to specify whether template matching (TM) cost is used to determine the filter or not. For example, when the flag is true, the TM based method is used, otherwise a conventional reference samples filter(s) is (are) used without checking the template.

In some aspects, template matching can be used to eliminate the least likely candidates filters that may apply on the reference samples. In some examples, N (N>2) filters with different tap and strength are available as candidates. Template matching can be used to reduce the number of candidate filters by removing the filters with larger template matching cost values on template area (also referred to as template region).

In some examples, a flag is signal to indicate the template matching is used or not to reduce the length of candidate list.

In some aspects, template matching can be used to determine the usage of a certain intra coding tool.

In some examples, the template matching cost can be used to determine the switch between PDP (a matrix based intra prediction) and regular intra prediction modes.

In some aspects, the template can be any available references. In some examples, the reconstructed areas that are geometrically close to the current blocks can be templates. In some examples, reconstructed area that has similar characteristic (BV, MV, IBC reference blocks etc.) can be used as template.

In some aspects, when there are multiple templates available, same candidate methods can be applied on all the available templates and using a weighted sum of all the template matching (TM) cost to make the final decision.

In some examples, the weights of different templates can be derived from the coded information or their relationship between current block.

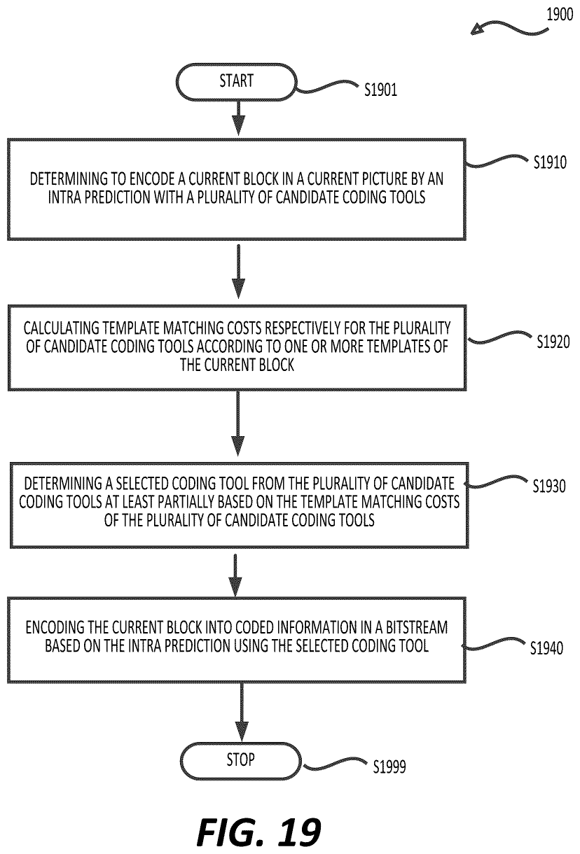

FIG. 18 shows a flow chart outlining a process (1800) according to an aspect of the disclosure. The process (1800) can be used in a video decoder. In various aspects, the process (1800) is executed by processing circuitry, such as the processing circuitry that performs functions of the video decoder (110), the processing circuitry that performs functions of the video decoder (210), and the like. In some aspects, the process (1800) is implemented in software instructions, thus when the processing circuitry executes the software instructions, the processing circuitry performs the process (1800). The process starts at (S1801) and proceeds to (S1810).

At (S1810), a coded video bitstream is received. The coded video bitstream includes coded information of a current block in a current picture, the coded information indicates that the current block is coded by an intra prediction with a plurality of candidate coding tools.

At (S1820), template matching costs respectively for the plurality of candidate coding tools are calculated according to one or more templates of the current block.

At (S1830), a selected coding tool from the plurality of candidate coding tools is determined at least partially based on the template matching costs of the plurality of candidate coding tools.

At (S1840), the current block is reconstructed based on the intra prediction using the selected coding tool.

Then, the process proceeds to (S1899) and terminates.

The process (1800) can be suitably adapted. Step(s) in the process (1800) can be modified and/or omitted. Additional step(s) can be added. Any suitable order of implementation can be used.

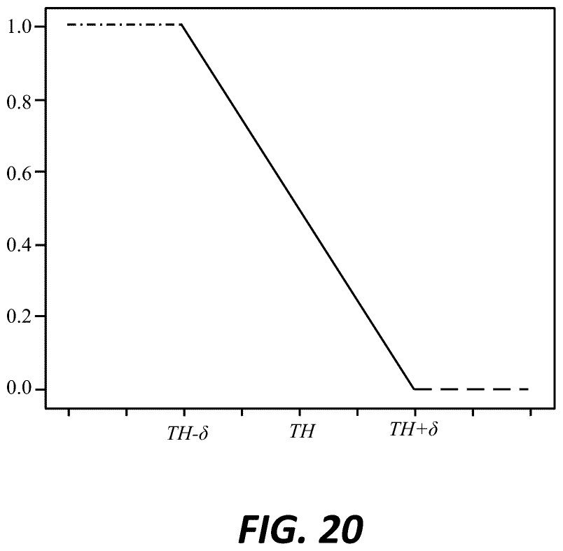

FIG. 19 shows a flow chart outlining a process (1900) according to an aspect of the disclosure. The process (1900) can be used in a video encoder. In various aspects, the process (1900) is executed by processing circuitry, such as the processing circuitry that performs functions of the video encoder (103), the processing circuitry that performs functions of the video encoder (303), and the like. In some aspects, the process (1900) is implemented in software instructions, thus when the processing circuitry executes the software instructions, the processing circuitry performs the process (1900). The process starts at (S1901) and proceeds to (S1910).

At (S1910), to encode a current block in a current picture by an intra prediction with a plurality of candidate coding tools is determined.

At (S1920), template matching costs respectively for the plurality of candidate coding tools are calculated according to one or more templates of the current block.

At (S1930), a selected coding tool from the plurality of candidate coding tools is determined at least partially based on the template matching costs of the plurality of candidate coding tools.

At (S1940), the current block is encoded into coded information in a bitstream based on the intra prediction using the selected coding tool.

Then, the process proceeds to (S1999) and terminates.

The process (1900) can be suitably adapted. Step(s) in the process (1900) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a current block in a current picture, the coded information indicates that the current block is coded by an intra prediction with a plurality of candidate coding tools. The format rule specifies that template matching costs respectively for the plurality of candidate coding tools are calculated according to one or more templates of the current block; a selected coding tool is determined from the plurality of candidate coding tools at least partially based on the template matching costs of the plurality of candidate coding tools; and the current block is reconstructed based on the intra prediction using the selected coding tool.

Some aspects of the disclosure provide techniques of pixelwise based multi-model blending. The techniques can be used for pixelwise blending when pixelwise multiple models are available.

In some video codecs, such as ECM, there are many pixel wised coding tools that can apply model derived or inherent from references. For example, multi-model extrapolation-based intra prediction (EIP), multi-model CCCM, multi-model CCLM, multi model LIC etc. In these coding tools, for example multi-model EIP, two or more models are available. The selection of which model to use can be based on the relationship between reference and a threshold. When the reference sample is larger than the threshold, model A is used. When the reference sample is smaller than the threshold, model B is used.

Some aspects of the disclosure provide techniques to use blending method on multiple models for pixelwise prediction/compensation by deriving the weight value using the difference between the reference samples and threshold. A threshold can be used for the multi-model derivation and pixelwise prediction/compensation of the multi-models.

In some aspects, the blending weight can be derived from predefined equation.

In some examples, linear equation can be used to derive the weight (e.g., wₐ for model A, w_{b} for model B), such as using Eq. (19) and Eq. (20), where the parameter α, β are predefined:

$${w}_{a} = max ( min ( 1 , α \times ( ref - TH ) + β ) , 0 ) \qquad Eq . ( 19 )$$

$${w}_{b} = 1 - {w}_{a} \qquad Eq . ( 20 )$$

In some examples, non-linear equations, such as Sigmod, tanh and the like, can be used to derive the weight (wₐ, w_{b}), such as using Eq. (21):

$${w}_{a} = \frac{1}{1 + {e}^{( ref - TH )}} \qquad Eq . ( 21 )$$

In some aspects, when there are N (N>2) models are available, blending can be used based on prediction from all/part of the models.

In some examples, N=3 and there are two thresholds (T1, T2) used as classifier. When ref<T1, model A is used, when ref is in [T1, T2], model B is used, when ref>T2, model C is used.

In some examples, for a given reference sample a, when a<T1, model A and model B's prediction value can be used to derive the prediction value.

In some examples, when an advanced classification is used to select the model, a probability for each model being used can be generated. The blending weight can be calculated as a function of probability (p), such as using Eq. (22):

$${w}_{i} = \frac{{p}_{i}}{{\sum }_{N} {p}_{i}} \qquad Eq . ( 22 )$$

In some aspects, the pixelwise blending can be applied adaptively based reference sample's value and other available information.

In some aspects, blending is applied when reference pixel value is in certain range, such as [TH−δ, TH+δ], TH is the threshold value, and δ can be a positive offset value from the threshold value.

In some examples, a linear weight derivation function is used.

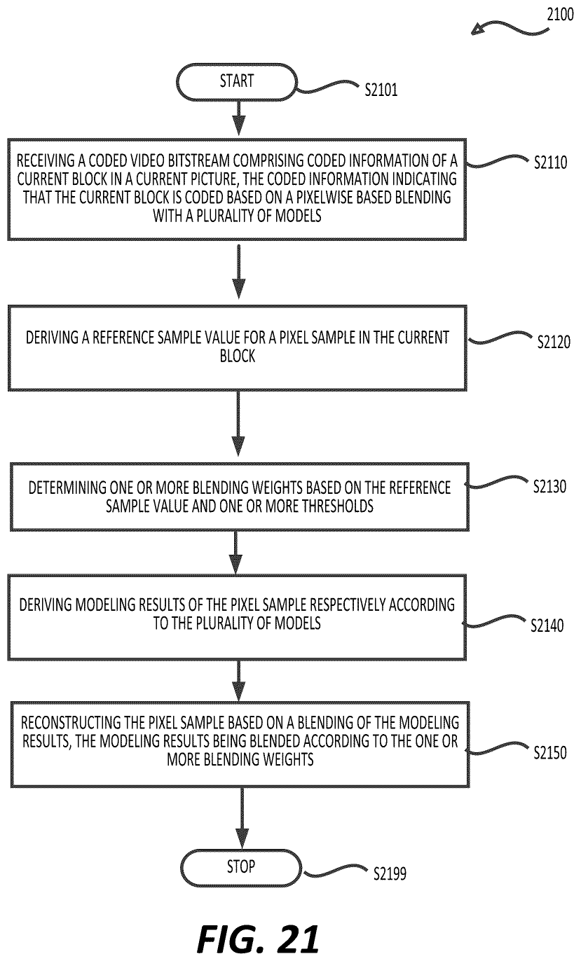

FIG. 20 shows a diagram of a linear weight derivation function in an example. In the FIG. 20 example, x-axis is reference value, and y-axis is the weight.

In some examples, the δ can be a predefined constant value, and the constant value can be signalled in high level syntax, such as SPS, PPS, slice header, picture header, and the like.

In some examples, the δ can be the function of regularization parameter which is derived from the histogram of the reference block.

In some examples, the δ can be derived from the dynamic range of sample value within the reference block.

In some aspects, the advanced classifier can be used to generate probability of each model.

In some examples, blending is be applied on top K highest possible models. The blending weight values can be the normalized probabilities across K probability (p), such as using Eq. (23)

$${w}_{i} = \frac{{p}_{i}}{{\sum }_{K} {p}_{i}} \qquad Eq . ( 23 )$$

In some examples, blending can be applied on models whose possibility is higher than certain threshold.

In some aspects, the pixelwise blending can be applied in all cases that meet the criteria without signaling.

In some aspects, there is a flag to control whether apply the pixelwise blending methods in TU/CU/Slice level.

In some aspects, the blending weight value(s) can be signaled in the bitstream in TU/CU/Slice level.

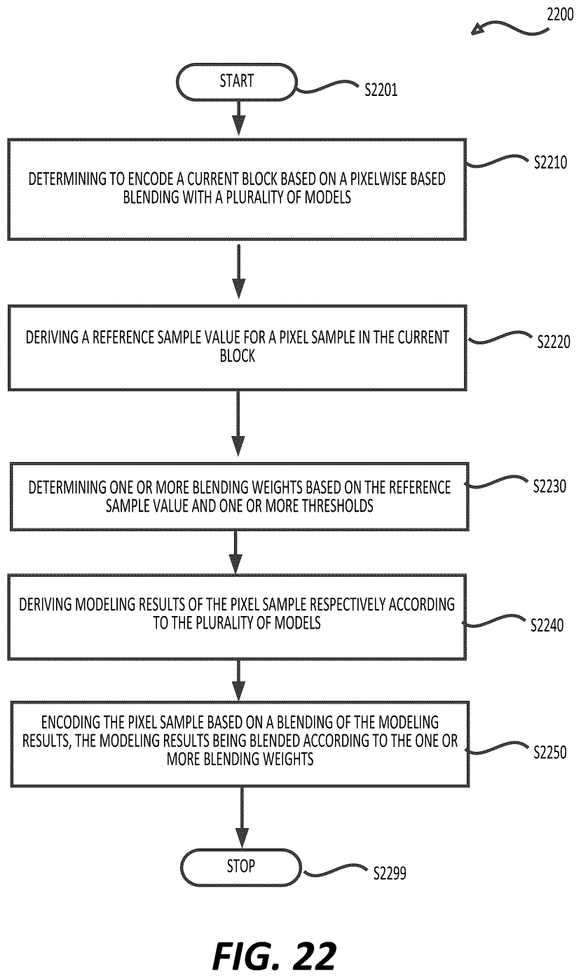

FIG. 21 shows a flow chart outlining a process (2100) according to an aspect of the disclosure. The process (2100) can be used in a video decoder. In various aspects, the process (2100) is executed by processing circuitry, such as the processing circuitry that performs functions of the video decoder (110), the processing circuitry that performs functions of the video decoder (210), and the like. In some aspects, the process (2100) is implemented in software instructions, thus when the processing circuitry executes the software instructions, the processing circuitry performs the process (2100). The process starts at (S2101) and proceeds to (S2110).

At (S2110), a coded video bitstream is received. The coded video bitstream includes coded information of a current block in a current picture, the coded information indicates that the current block is coded based on a pixelwise based blending with a plurality of models.

At (S2120), a reference sample value for a pixel sample in the current block is derived.

At (S2130), one or more blending weights is determined based on the reference sample value and one or more thresholds.

At (S2140), modeling results of the pixel sample are calculated (derived) respectively according to the plurality of models.

At (S2150), the pixel sample is reconstructed based on a blending of the modeling results, the modeling results are blended according to the one or more blending weights.

Then, the process proceeds to (S2199) and terminates.

The process (2100) can be suitably adapted. Step(s) in the process (2100) can be modified and/or omitted. Additional step(s) can be added. Any suitable order of implementation can be used.

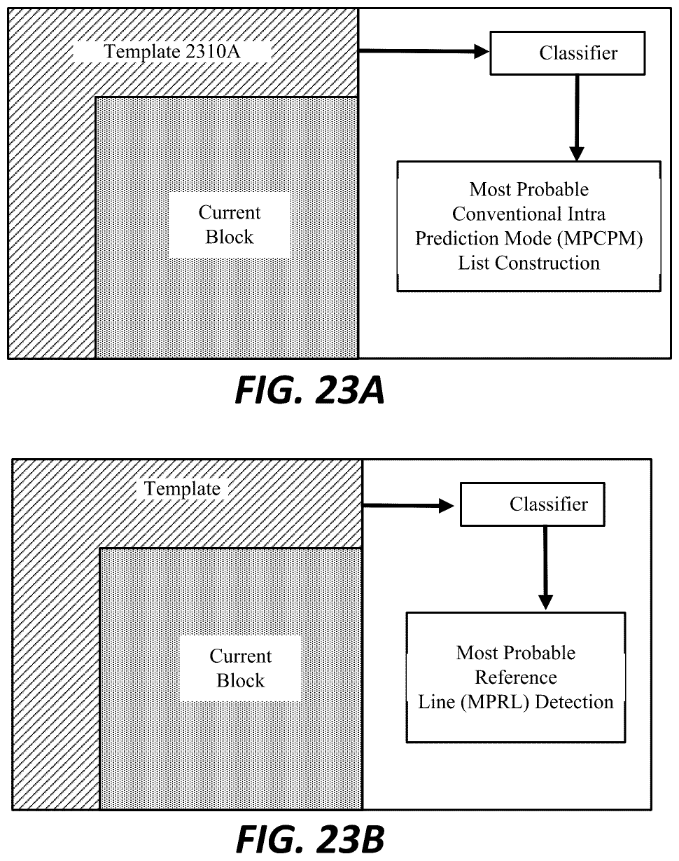

FIG. 22 shows a flow chart outlining a process (2200) according to an aspect of the disclosure. The process (2200) can be used in a video encoder. In various aspects, the process (2200) is executed by processing circuitry, such as the processing circuitry that performs functions of the video encoder (103), the processing circuitry that performs functions of the video encoder (303), and the like. In some aspects, the process (2200) is implemented in software instructions, thus when the processing circuitry executes the software instructions, the processing circuitry performs the process (2200). The process starts at (S2201) and proceeds to (S2210).

At (S2210), to encode a current block based on a pixelwise based blending with a plurality of models is determined.

At (S2220), a reference sample value for a pixel sample in the current block is derived.

At (S2230), one or more blending weights are determined based on the reference sample value and one or more thresholds.

At (S2240), modeling results of the pixel sample are derived (calculated) respectively according to the plurality of models.

At (S2250), the pixel sample is encoded based on a blending of the modeling results, the modeling results being blended according to the one or more blending weights. Then, the process proceeds to (S2299) and terminates.

The process (2200) can be suitably adapted. Step(s) in the process (2200) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a current block in a current picture, the coded information indicates that the current block is coded based on a pixelwise based blending with a plurality of models. The format rule specifies that a reference sample value for a pixel sample in the current block is derived; one or more blending weights are determined based on the reference sample value and one or more thresholds; modeling results of the pixel sample are derived respectively according to the plurality of models; and the pixel sample is reconstructed based on a blending of the modeling results, the modeling results being blended according to the one or more blending weights.

### Some Aspects of the Disclosure Provide Techniques for Intra Prediction Mode Improvement

Some aspects of the disclosure provide techniques to apply a classifier on the neighboring reconstructed reference region to determine the classification of the intra prediction mode. The classification can be used for the prediction of the intra prediction mode at the decoder. In some examples, the classifier can be any kind of classifier by using pixel samples within the neighboring reconstructed reference region as input, and the output, also called classification, can indicate the probability of the intra prediction mode for the current block, the ranking of the intra prediction modes for the current block, the most probable intra prediction mode for the current block, or the most probable reference line for the current block.

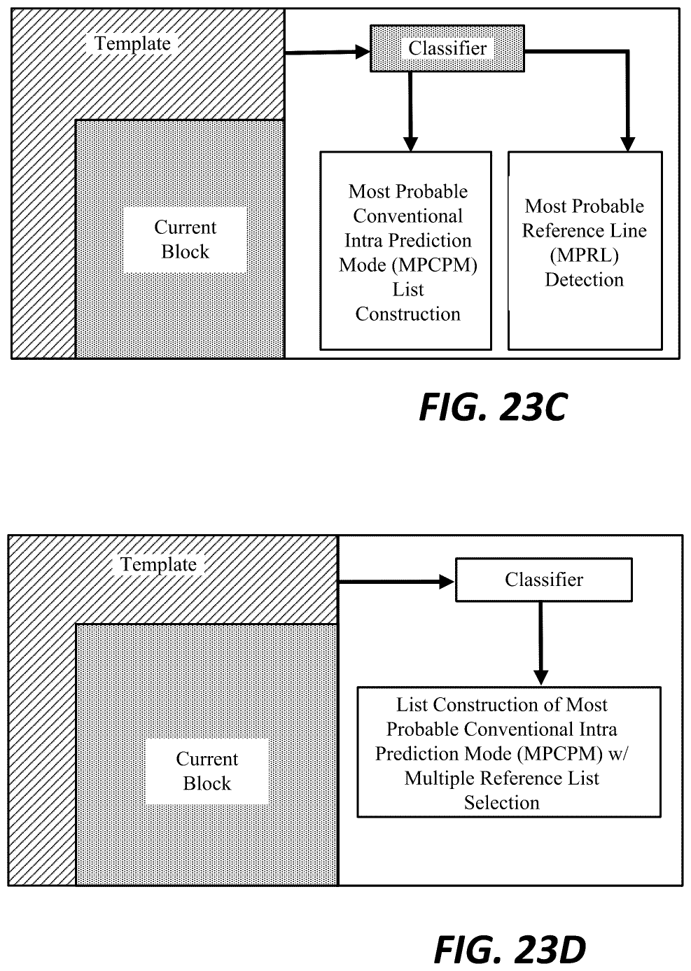

FIGS. 23A-23D show examples of the classifier usage for the intra prediction mode. The neighboring reconstructed reference region which is used for the classifier is referred to as template in the FIGS. 23A-23D.

In some aspects, the neighboring reconstructed reference region, such as the template (2310A) in FIG. 23A can be different to the reference data for the intra prediction mode. In some examples, the reference data of the intra prediction mode is a part of the neighboring reconstructed reference region (2310A).

In some aspects, the classifier can be any suitable neural-network based classifier.

In some aspects, the classifier can be a selected classifier from a classifier set. The classifier set is a predefined set, and a syntax is signaled to indicate which classifier in the classifier set is used (selected), the syntax can be at a level of a slice header, picture header, coding block, CTU, and the like.

In some aspects, the techniques are applied to only the angular intra prediction, including but not limited to traditional angular intra prediction mode, matrix based intra prediction replacing existing conventional intra modes (PDP a matrix based intra prediction) and the like.

In an example, an index is signaled for the coding block to indicate which intra prediction is selected after the classification. One example is shown in FIG. 1(a).

In some aspects, the syntax can be the syntax of most probable mode (MPM) with list size N. The first N candidates after the classification with highest probability or ranking are used for the MPM list construction in order.

In an example, the most probable mode (MPM) can be primary MPM.

In another example, the most probable mode (MPM) can be secondary MPM

In some examples, the syntax can be the syntax of most probable mode (MPM) with list size N. The first candidate in the MPM list is planar mode, and then the first N−1 candidates after the classification with highest probability or ranking are used for the MPM list construction in order.

In some examples, an index syntax is signaled for the non-MPM candidate list to indicate which intra prediction mode within the non-MPM candidate list is selected after the classification.

In some examples, a flag is signaled to indicate whether the classifier based technique is used or not. When the flag is true, another syntax is signaled to indicate which intra prediction mode after the classification is selected.

In some aspects, a syntax is derived by using the classification and is signaled to indicate which reference line is selected for the coding block, such as shown in FIG. 23B.

In some aspects, a flag is signaled to indicate whether the derivation of the multiple reference line by using the classification is used or not. The derived reference line can be applied on the intra prediction mode when the flag is true.

In some aspects, a syntax is signaled to indicate which combination of the intra prediction mode and the associated reference line is used in the list. The list is constructed by using the most probable order of the combination of the intra prediction mode and the multiple reference lines, such as shown by FIG. 23D.

In some aspects, the final prediction is a fusion of two or more predictors.

In some examples, the two or more predictors correspond to the prediction signal derived by applying one of the intra modes in the ranked list.

In some examples, the ranked list can be the MPM list, such as in FIG. 23A, or the MPM list wherein the entry also includes reference line, such as in FIG. 23D.

In some aspects, the template area (also referred to as the reference area) is extended to a pre-defined area including non-adjacent blocks.

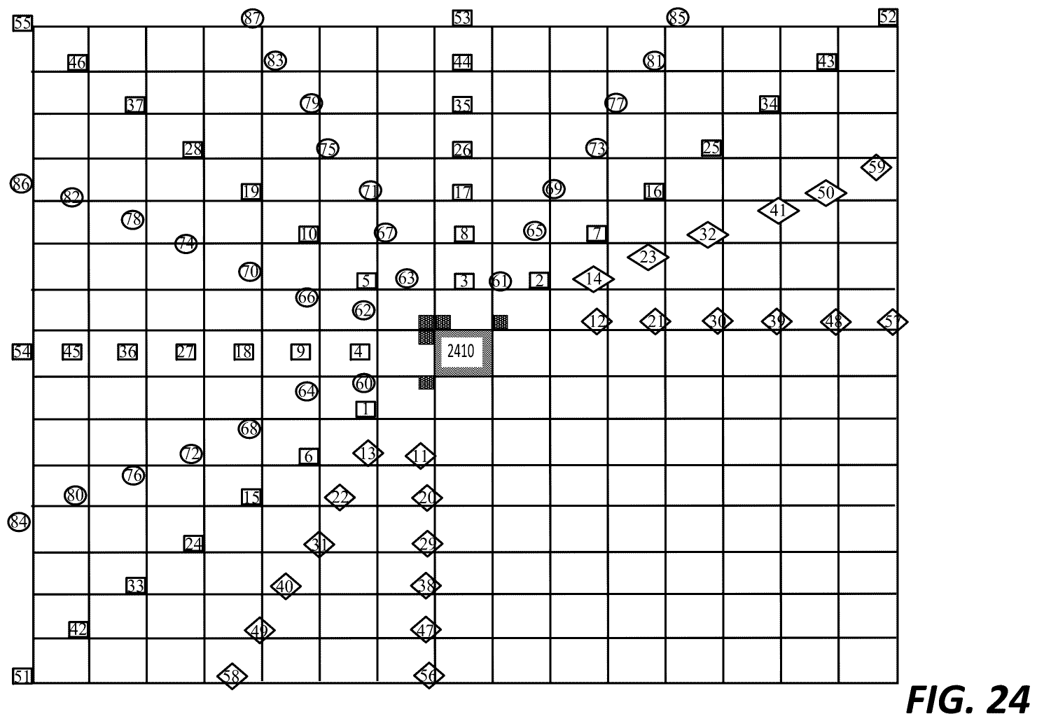

FIG. 24 shows a diagram of a pre-defined area including no-adjacent blocks in an example. In the FIG. 24 example, a current block (2410) has a predefined template aera (also referred to as reference area) with samples scattered to predefined positions, such as positions labeled 1-87 in FIG. 24.

In some examples, the input samples within this reference area are scattered to the pre-defined positions such as shown in FIG. 24.

In some aspects, the classifier can be applied to block-vector guided reference template. In some examples, when neighboring information contains a block vector, the classifier can be applied to corresponding reference template.

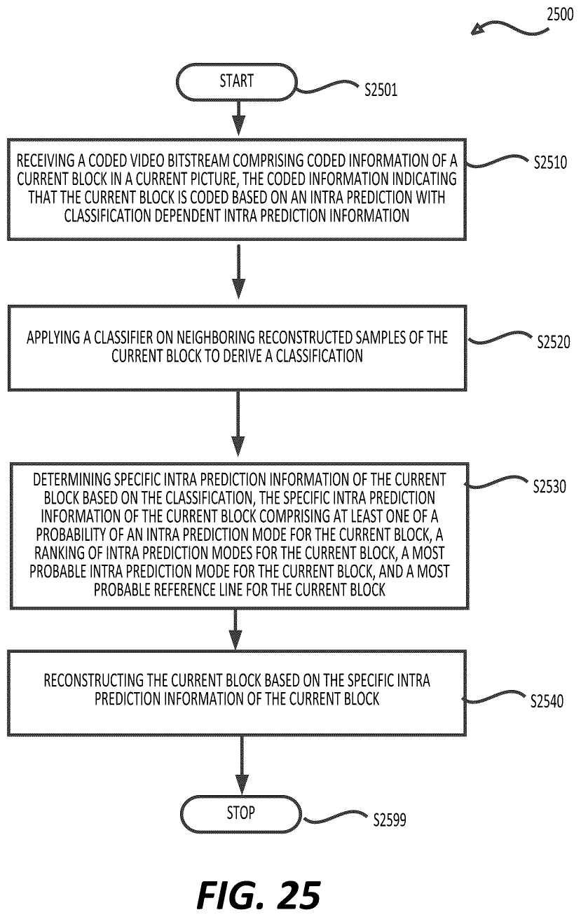

FIG. 25 shows a flow chart outlining a process (2500) according to an aspect of the disclosure. The process (2500) can be used in a video decoder. In various aspects, the process (2500) is executed by processing circuitry, such as the processing circuitry that performs functions of the video decoder (110), the processing circuitry that performs functions of the video decoder (210), and the like. In some aspects, the process (2500) is implemented in software instructions, thus when the processing circuitry executes the software instructions, the processing circuitry performs the process (2500). The process starts at (S2501) and proceeds to (S2510).

At (S2510), a coded video bitstream is received. The coded video bitstream includes coded information of a current block in a current picture, the coded information indicates that the current block is coded based on an intra prediction with classification dependent intra prediction information

At (S2520), a classifier is applied on neighboring reconstructed samples of the current block to derive a classification.

At (S2530), specific intra prediction information of the current block is determined based on the classification, the specific intra prediction information of the current block includes at least one of a probability of an intra prediction mode for the current block, a ranking of intra prediction modes for the current block, a most probable intra prediction mode for the current block, and a most probable reference line for the current block.

At (S2540), the current block is reconstructed based on the specific intra prediction information of the current block.

Then, the process proceeds to (S2599) and terminates.

The process (2500) can be suitably adapted. Step(s) in the process (2500) can be modified and/or omitted. Additional step(s) can be added. Any suitable order of implementation can be used.

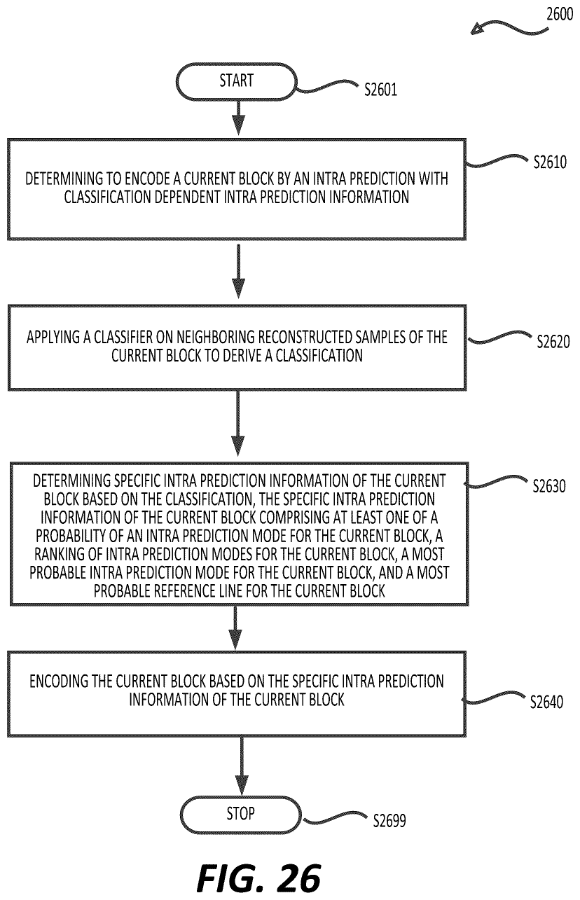

FIG. 26 shows a flow chart outlining a process (2600) according to an aspect of the disclosure. The process (2600) can be used in a video encoder. In various aspects, the process (2600) is executed by processing circuitry, such as the processing circuitry that performs functions of the video encoder (103), the processing circuitry that performs functions of the video encoder (303), and the like. In some aspects, the process (2600) is implemented in software instructions, thus when the processing circuitry executes the software instructions, the processing circuitry performs the process (2600). The process starts at (S2601) and proceeds to (S2610).

At (S2610), to encode a current block by an intra prediction with classification dependent intra prediction information is determined.

At (S2620), a classifier is applied on neighboring reconstructed samples of the current block to derive a classification.

At (S2630), specific intra prediction information of the current block is determined based on the classification, the specific intra prediction information of the current block includes at least one of a probability of an intra prediction mode for the current block, a ranking of intra prediction modes for the current block, a most probable intra prediction mode for the current block, and a most probable reference line for the current block

At (S2640), the current block is encoded based on the specific intra prediction information of the current block.

Then, the process proceeds to (S2699) and terminates.

The process (2600) can be suitably adapted. Step(s) in the process (2600) can be modified and/or omitted. Additional step(s) can be added. Any suitable order of implementation can be used.

According to an aspect of the disclosure, a method of processing visual media data is provided. In the method, a conversion between a visual media file and a bitstream of visual media data is performed according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an example, the bitstream carries coded information of a current block in a current picture, the coded information indicates that the current block is coded based on an intra prediction with classification dependent intra prediction information. The format rule specifies that a classifier is applied on neighboring reconstructed samples of the current block to derive a classification; specific intra prediction information of the current block is determined based on the classification, the specific intra prediction information of the current block comprising at least one of a probability of an intra prediction mode for the current block, a ranking of intra prediction modes for the current block, a most probable intra prediction mode for the current block, and a most probable reference line for the current block; and the current block is reconstructed based on the specific intra prediction information of the current block.

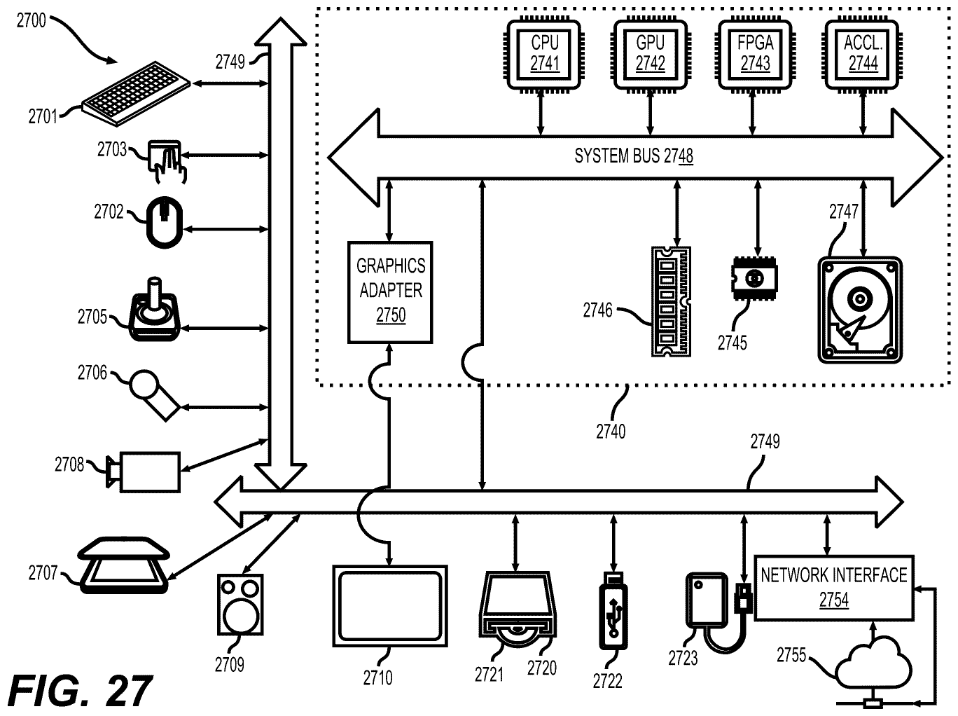

The techniques described above, can be implemented as computer software using computer-readable instructions and physically stored in one or more computer-readable media. For example, FIG. 27 shows a computer system (2700) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 27 for computer system (2700) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of computer system (2700).

Computer system (2700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (2701), mouse (2702), trackpad (2703), touch screen (2710), data-glove (not shown), joystick (2705), microphone (2706), scanner (2707), camera (2708).

Computer system (2700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (2710), data-glove (not shown), or joystick (2705), but there can also be tactile feedback devices that do not serve as input devices), audio output devices (such as: speakers (2709), headphones (not depicted)), visual output devices (such as screens (2710) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (2700) can also include human accessible storage devices and their associated media such as optical media including CD/DVD ROM/RW (2720) with CD/DVD or the like media (2721), thumb-drive (2722), removable hard drive or solid state drive (2723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (2700) can also include an interface (2754) to one or more communication networks (2755). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (2749) (such as, for example USB ports of the computer system (2700)); others are commonly integrated into the core of the computer system (2700) by attachment to a system bus as described below (for example Ethernet interface into a PC computer system or cellular network interface into a smartphone computer system). Using any of these networks, computer system (2700) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (2740) of the computer system (2700).

The core (2740) can include one or more Central Processing Units (CPU) (2741), Graphics Processing Units (GPU) (2742), specialized programmable processing units in the form of Field Programmable Gate Areas (FPGA) (2743), hardware accelerators for certain tasks (2744), graphics adapters (2750), and so forth. These devices, along with Read-only memory (ROM) (2745), Random-access memory (2746), internal mass storage such as internal non-user accessible hard drives, SSDs, and the like (2747), may be connected through a system bus (2748). In some computer systems, the system bus (2748) can be accessible in the form of one or more physical plugs to enable extensions by additional CPUs, GPU, and the like. The peripheral devices can be attached either directly to the core's system bus (2748), or through a peripheral bus (2749). In an example, the screen (2710) can be connected to the graphics adapter (2750). Architectures for a peripheral bus include PCI, USB, and the like.

CPUs (2741), GPUs (2742), FPGAs (2743), and accelerators (2744) can execute certain instructions that, in combination, can make up the aforementioned computer code. That computer code can be stored in ROM (2745) or RAM (2746). Transitional data can also be stored in RAM (2746), whereas permanent data can be stored for example, in the internal mass storage (2747). Fast storage and retrieve to any of the memory devices can be enabled through the use of cache memory, that can be closely associated with one or more CPU (2741), GPU (2742), mass storage (2747), ROM (2745), RAM (2746), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (2700), and specifically the core (2740) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (2740) that are of non-transitory nature, such as core-internal mass storage (2747) or ROM (2745). The software implementing various aspects of the present disclosure can be stored in such devices and executed by core (2740). A computer-readable medium can include one or more memory devices or chips, according to particular needs. The software can cause the core (2740) and specifically the processors therein (including CPU, GPU, FPGA, and the like) to execute particular processes or particular parts of particular processes described herein, including defining data structures stored in RAM (2746) and modifying such data structures according to the processes defined by the software. In addition or as an alternative, the computer system can provide functionality as a result of logic hardwired or otherwise embodied in a circuit (for example: accelerator (2744)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1). A method of video decoding, including: receiving a coded video bitstream including coded information of a current block in a current picture, the coded information indicating that the current block is coded by an intra prediction using an affine intra mode (AIM) model; determining the affine intra mode model for applying on the current block; determining at least a first intra angular mode for a first sample in the current block and a second intra angular mode for a second sample in the current block according to the affine intra mode model, the first intra angular mode being different from the second intra angular mode; and reconstructing the current block based on the intra prediction using the affine intra mode model, the first sample being predicted based on the first intra angular mode and the second sample being predicted based on the second intra angular mode.

(2). The method of feature (1), in which the determining the affine intra mode model includes at least one of: deriving the affine intra mode model based on one or more intra angular modes associated with neighboring blocks of the current block; and determining the affine intra mode model based on one or more syntaxes in the coded information of the current block.

(3). The method of any of features (1) to (2), in which the affine intra mode model is used to derive at least one of an angle, vectors associated with the angle, one or more trigonometric function value of the angle for a location in the current block.

(4). The method of any of features (1) to (3), in which the affine intra mode model is configured to derive an angle for a location in the current block, and the method further includes: determining an intra angular mode associated with the angle according to a predefined angle table that maps angles to intra angular modes.

(5). The method of any of features (1) to (4), in which the coded information of the current block includes a flag that indicates whether the current block is coded by using the affine intra mode model.

(6). The method of any of features (1) to (5), in which the determining the affine intra mode model further includes: deriving the affine intra mode model based on two or more control point intra modes (CPIMs), a CPIM being an intra angular mode associated with a neighboring block of the current block in the current picture.

(7). The method of any of features (1) to (6), in which a first CPIM associated with a first neighboring block and a second CPIM associated with a second neighboring block are available, the deriving the affine intra mode model includes: deriving the affine intra mode model based on the first CPIM and the second CPIM.

(8). The method of any of features (1) to (7), in which a first CPIM associated with a first neighboring block and a second CPIM associated with a second neighboring block are available, the deriving the affine intra mode model includes: deriving a third CPIM associated with a third neighboring block of the current block based on the first CPIM and the second CPIM; and deriving the affine intra mode model based on the first CPIM, the second CPIM and the third CPIM.

(9). The method of any of features (1) to (8), in which a first CPIM associated with a first neighboring block, a second CPIM associated with a second neighboring block and a third CPIM associated with a third neighboring block are available, the deriving the affine intra mode model includes: deriving the affine intra mode model based on the first CPIM, the second CPIM and the third CPIM.

(10). The method of any of features (1) to (9), in which a plurality of CPIMs are available, the deriving the affine intra mode model includes: constructing a combination list from the plurality of CPIMs, the combination list including combination candidates of CPIMs, a combination candidate being a combination of two or three CPIMs from the plurality of CPIMs; determining a selected combination candidate from the combination list based on an index that is signaled in the coded video bitstream; and deriving the affine intra mode model based on the selected combination candidate.

(11). The method of any of features (1) to (10), in which the determining the affine intra mode model includes: determining the affine intra mode model by a regression model using two or more intra angular modes associated with neighboring blocks of the current block.

(12). The method of any of features (1) to (11), further including: when a first intra mode associated with a first neighboring block of the current block is not an angular mode, replacing the first intra mode with a second intra mode to be associated with the first neighboring block, the second intra mode being an angular mode, the second intra mode associated with the first neighboring block being one of the two or more CPIMs that are used to derive the affine intra mode model.

(13). The method of any of features (1) to (12), in which the second intra mode is at least one of: a default angular mode; an angular mode that is derived by a decoder-side intra mode derivation from a template of the current block; and/or an angular mode that is derived by a decoder-side intra mode derivation from a reference block of the current block, the reference block being indicated by at least one of a block vector and/or a motion vector.

(14). The method of any of features (1) to (13), in which the determining the affine intra mode model further includes at least one of: determining the affine intra mode model based on a base intra angular mode and a delta value when the affine intra mode model is a 4-parameter model, the base intra angular mode and the delta value being decoded from the coded video bitstream; and determining the affine intra mode model based on a base intra angular mode, a first delta value and a second delta value when the affine intra mode model is a 6-parameter model, the base intra angular mode, the first delta value and the second delta value being decoded from the coded video bitstream.

(15). The method of any of features (1) to (14), in which the determining at least the first intra angular mode for the first sample and the second intra angular mode for the second sample includes: determining intra angular modes in a sample-wise for samples in the current block according to the affine intra mode model.

(16). The method of any of features (1) to (15), in which the determining at least the first intra angular mode for the first sample and the second intra angular mode for the second sample includes: determining the first intra angular mode for a first subblock of the current block including the first sample, and the second intra angular mode for a second subblock of the current block including the second sample.

(17). The method of any of features (1) to (16), in which the reconstructing includes: generating first predicted samples of a first line in the current block; and generating second predicted samples of a second line in the current block by using the first predicted samples as reference samples.

(18). The method of any of features (1) to (17), in which the determining at least the first intra angular mode for the first sample and the second intra angular mode for the second sample includes: deriving an angle-depending value for a sample in the current block, the angle-depending value indicating a prediction angle of the sample; and when the prediction angle is out of an angle range of a set of intra angular modes, determining a specific intra angular mode for the sample, the specific intra angular mode being a clipped intra angular mode in the set of intra angular modes that has a closest mapping angle to the prediction angle.

(19). The method of any of features (1) to (18), in which the reconstructing the current block includes: generating a prediction block of the current block based on the affine intra mode model, the prediction block including the first sample that is predicted based on the first intra angular mode and the second sample that is predicted based on the second intra angular mode; and applying at least one of a position dependent filter, a smooth filter and a sharpening filter on the prediction block.

(20). A method of video encoding, including: determining to code a current block in a current picture by an intra prediction using an affine intra mode model; determining the affine intra mode model for applying on the current block; determining at least a first intra angular mode for a first sample in the current block and a second intra angular mode for a second sample in the current block according to the affine intra mode model, the first intra angular mode being different from the second intra angular mode; and encoding the current block into coded information of the current block based on the intra prediction using the affine intra mode model, the first sample being predicted based on the first intra angular mode and the second sample being predicted based on the second intra angular mode.

(21). The method of feature (20), in which the determining the affine intra mode model includes: deriving the affine intra mode model based on one or more intra angular modes associated with neighboring blocks of the current block.

(22). The method of any of features (20) to (21), in which the encoding the current block includes: including one or more syntaxes into the coded information of the current block, the one or more syntaxes indicating the affine intra mode model.

(23). The method of any of features (20) to (22), in which the affine intra mode model is used to derive at least one of an angle, vectors associated with the angle, one or more trigonometric function value of the angle for a location in the current block.

(24). The method of any of features (20) to (23), in which the affine intra mode model is configured to derive an angle for a location in the current block, and the method further includes: determining an intra angular mode associated with the angle according to a predefined angle table that maps angles to intra angular modes.

(25). The method of any of features (20) to (24), in which the encoding includes: including a flag into the coded information of the current block, the flag indicating whether the current block is coded by using the affine intra mode model.

(26). The method of any of features (20) to (25), in which the determining the affine intra mode model further includes: deriving the affine intra mode model based on two or more control point intra modes (CPIMs), a CPIM being an intra angular mode associated with a neighboring block of the current block in the current picture.

(27). The method of any of features (20) to (26), in which a first CPIM associated with a first neighboring block and a second CPIM associated with a second neighboring block are available, the deriving the affine intra mode model includes: deriving the affine intra mode model based on the first CPIM and the second CPIM.

(28). The method of any of features (20) to (27), in which a first CPIM associated with a first neighboring block and a second CPIM associated with a second neighboring block are available, the deriving the affine intra mode model includes: deriving a third CPIM associated with a third neighboring block of the current block based on the first CPIM and the second CPIM; and deriving the affine intra mode model based on the first CPIM, the second CPIM and the third CPIM.

(29). The method of any of features (20) to (28), in which a first CPIM associated with a first neighboring block, a second CPIM associated with a second neighboring block and a third CPIM associated with a third neighboring block are available, the deriving the affine intra mode model includes: deriving the affine intra mode model based on the first CPIM, the second CPIM and the third CPIM.

(30). The method of any of features (20) to (29), in which a plurality of CPIMs are available, the deriving the affine intra mode model includes: constructing a combination list from the plurality of CPIMs, the combination list including combination candidates of CPIMs, a combination candidate being a combination of two or three CPIMs from the plurality of CPIMs; determining a selected combination candidate from the combination list; deriving the affine intra mode model based on the selected combination candidate; and including a signal indicative of the selected combination candidate into the coded information of the current block.

(31). The method of any of features (20) to (30), in which the determining the affine intra mode model includes: determining the affine intra mode model by a regression model using two or more intra angular modes associated with neighboring blocks of the current block.

(32). The method of any of features (20) to (31), further including: when a first intra mode associated with a first neighboring block of the current block is not an angular mode, replacing the first intra mode with a second intra mode to be associated with the first neighboring block, the second intra mode being an angular mode, the second intra mode associated with the first neighboring block being one of the two or more CPIMs that are used to derive the affine intra mode model.

(33). The method of any of features (20) to (32), in which the second intra mode is at least one of: a default angular mode; an angular mode that is derived by a decoder-side intra mode derivation from a template of the current block; and/or an angular mode that is derived by a decoder-side intra mode derivation from a reference block of the current block, the reference block being indicated by at least one of a block vector and/or a motion vector.

(34). The method of any of features (20) to (33), in which the encoding includes at least one of: including a base intra angular mode and a delta value into the coded information of the current block when the affine intra mode model is a 4-parameter model, the base intra angular mode and the delta value indicating the 4-parameter model; and including a base intra angular mode, a first delta value and a second delta value into the coded information of the current block when the affine intra mode model is a 6-parameter model, the base intra angular mode, the first delta value and the second delta value indicating the 6-parameter model.

(35). The method of any of features (20) to (34), in which the determining at least the first intra angular mode for the first sample and the second intra angular mode for the second sample includes: determining intra angular modes in a sample-wise for samples in the current block according to the affine intra mode model.

(36). The method of any of features (20) to (35), in which the determining at least the first intra angular mode for the first sample and the second intra angular mode for the second sample includes: determining the first intra angular mode for a first subblock of the current block that includes the first sample, and the second intra angular mode for a second subblock of the current block that includes the second sample.

(37). The method of any of features (20) to (36), in which the encoding includes: generating first predicted samples of a first line in the current block; and generating second predicted samples of a second line in the current block by using the first predicted samples as reference samples.

(38). The method of any of features (20) to (37), in which the determining at least the first intra angular mode for the first sample and the second intra angular mode for the second sample includes: deriving an angle-depending value for a sample in the current block, the angle-depending value indicating a prediction angle of the sample; and when the prediction angle is out of an angle range of a set of intra angular modes, determining a specific intra angular mode for the sample, the specific intra angular mode being a clipped intra angular mode in the set of intra angular modes that has a closest mapping angle to the prediction angle.

(39). The method of any of features (20) to (38), in which the encoding includes: generating a prediction block of the current block based on the affine intra mode model, the prediction block including the first sample that is predicted based on the first intra angular mode and the second sample that is predicted based on the second intra angular mode; and applying at least one of a position dependent filter, a smooth filter and a sharpening filter on the prediction block.

(40). A method of processing visual media data, the method including: processing a bitstream of visual media data according to a format rule, in which: the bitstream includes coded information of a current block in a current picture, the coded information indicating that the current block is coded by an intra prediction using an affine intra mode model; and the format rule specifies that: the affine intra mode model for applying on the current block is determined; at least a first intra angular mode for a first sample in the current block and a second intra angular mode for a second sample in the current block are determined according to the affine intra mode model, the first intra angular mode being different from the second intra angular mode; and the current block is reconstructed based on the intra prediction using the affine intra mode model, the first sample being predicted based on the first intra angular mode and the second sample being predicted based on the second intra angular mode.

(41). A method of video decoding, including: receiving a coded video bitstream including coded information of a current block in a current picture, the coded information indicating that the current block is coded by a matrix based intra prediction (MIP) using at least an online trained matrix; deriving a first matrix based on reconstructed samples in the current picture, the reconstructed samples including first reconstructed samples and second reconstructed samples, the first reconstructed samples being set as a reference for the deriving of the first matrix, the second reconstructed samples being set as a target for the deriving of the first matrix; and reconstructing the current block based on the MIP using at least the first matrix, the MIP including a plurality of prediction samples that are output from a matrix multiplication with the first matrix.

(42). The method of feature (41), in which the reconstructed samples are in reference lines, the first reconstructed samples are in in a first reference line in the reference lines, the second reconstructed samples are in one or more second reference lines in the reference lines.

(43). The method of any of features (41) to (42), in which the first reference line and the one or more second reference lines are at least one of: L-shaped lines; vertical lines; or horizontal lines.

(44). The method of any of features (41) to (43), in which the deriving the first matrix includes: deriving the first matrix based on at least one of a regression algorithm, a machine learning algorithm, and an optimization system.

(45). The method of any of features (41) to (44), further including:
deriving a second matrix based on the reconstructed samples in the current picture; generating a plurality of first prediction samples from a first matrix multiplication with the first matrix, the plurality of first prediction samples including a first prediction for a sample in the current block; generating a plurality of second prediction samples from a second matrix multiplication with the second matrix, the plurality of second prediction samples including a second prediction for the sample in the current block; and calculating a weighted sum of at least the first prediction and the second prediction to be a matrix based intra prediction of the sample in the current block.

(46). The method of any of features (41) to (45), further including: calculating one or more weight values based on the reconstructed samples in the current picture.

(47). The method of any of features (41) to (46), in which a counting number of the reference lines is larger than at least one of a height or a width of the current block, and the reconstructing includes: generating a matrix based intra prediction block of the current block from a single matrix multiplication with the first matrix.

(48). The method of any of features (41) to (47), in which a counting number of the reference lines is less than both a height and a width of the current block, and the reconstructing includes: generating first matrix based intra prediction samples from a first matrix multiplication with the first matrix, the first matrix based intra prediction samples being a first portion of the current block; and generating second matrix based intra prediction samples from a second matrix multiplication with the first matrix using one or more of the first matrix based intra prediction samples as a reference, the second matrix based intra prediction samples being a second portion of the current block that includes at least a non-overlapping sample with the first portion.

(49). The method of any of features (41) to (48), in which a counting number of the reference lines is less than both a height and a width of the current block, and the reconstructing includes: generating first matrix based intra prediction samples from a first matrix multiplication with the first matrix, the first matrix based intra prediction samples being a first portion of the current block; deriving a second matrix based on the reconstructed samples and at least one prediction sample in the first matrix based intra prediction samples; and generating second matrix based intra prediction samples from a second matrix multiplication with the second matrix using one or more of the first matrix based intra prediction samples as a reference, the second matrix based intra prediction samples being a second portion of the current block that includes at least a non-overlapping sample with the first portion.

(50). A method of video encoding, including: determining to encode a current block in a current picture by a matrix based intra prediction (MIP) using at least an online trained matrix; deriving a first matrix based on reconstructed samples in the current picture, the reconstructed samples including first reconstructed samples and second reconstructed samples, the first reconstructed samples being set as a reference for the deriving of the first matrix, the second reconstructed samples being set as a target for the deriving of the first matrix; and encoding the current block into coded information of the current block based on the MIP using at least the first matrix, the MIP including a plurality of prediction samples that are output from a matrix multiplication with the first matrix.

(51). The method of feature (50), in which the reconstructed samples are in reference lines, the first reconstructed samples are in in a first reference line in the reference lines, the second reconstructed samples are in one or more second reference lines in the reference lines.

(52). The method of any of features (50) to (51), in which the first reference line and the one or more second reference lines are at least one of: L-shaped lines; vertical lines; or horizontal lines.

(53). The method of any of features (50) to (52), in which the deriving the first matrix includes: deriving the first matrix based on at least one of a regression algorithm, a machine learning algorithm, and an optimization system.

(54). The method of any of features (50) to (53), further including: deriving a second matrix based on the reconstructed samples in the current picture; generating a plurality of first prediction samples from a first matrix multiplication with the first matrix, the plurality of first prediction samples including a first prediction for a sample in the current block; generating a plurality of second prediction samples from a second matrix multiplication with the second matrix, the plurality of second prediction samples including a second prediction for the sample in the current block; and calculate a weighted sum of at least the first prediction and the second prediction to be a matrix based intra prediction of the sample in the current block.

(55). The method of any of features (50) to (54), further including: calculating one or more weight values based on the reconstructed samples in the current picture.

(56). The method of any of features (50) to (55), in which a counting number of the reference lines is larger than at least one of a height or a width of the current block, and the reconstructing includes: generating a matrix based intra prediction block of the current block from a single matrix multiplication with the first matrix.

(57). The method of any of features (50) to (56), in which a counting number of the reference lines is less than both a height and a width of the current block, and the reconstructing includes: generating first matrix based intra prediction samples from a first matrix multiplication with the first matrix, the first matrix based intra prediction samples being a first portion of the current block; and generating second matrix based intra prediction samples from a second matrix multiplication with the first matrix using one or more of the first matrix based intra prediction samples as a reference, the second matrix based intra prediction samples being a second portion of the current block that includes at least a non-overlapping sample with the first portion.

(58). The method of any of features (50) to (57), in which a counting number of the reference lines is less than both a height and a width of the current block, and the reconstructing includes: generating first matrix based intra prediction samples from a first matrix multiplication with the first matrix, the first matrix based intra prediction samples being a first portion of the current block; deriving a second matrix based on the reconstructed samples and at least one prediction sample in the first matrix based intra prediction samples; and generating second matrix based intra prediction samples from a second matrix multiplication with the second matrix using one or more of the first matrix based intra prediction samples as a reference, the second matrix based intra prediction samples being a second portion of the current block that includes at least a non-overlapping sample with the first portion.

(59). A method of processing visual media data, the method including: processing a bitstream of visual media data according to a format rule, in which: the bitstream includes coded information of a current block in a current picture, the coded information indicating that the current block is coded by a matrix based intra prediction (MIP) using at least an online trained matrix; and the format rule specifies that: a first matrix is derived based on reconstructed samples in the current picture, the reconstructed samples including first reconstructed samples and second reconstructed samples, the first reconstructed samples being set as a reference for the deriving of the first matrix, the second reconstructed samples being set as a target for the deriving of the first matrix; and the current block is reconstructed based on the MIP using at least the first matrix, the MIP including a plurality of prediction samples that are output from a matrix multiplication with the first matrix.

(60). A method of video decoding, including: receiving a coded video bitstream including coded information of a current block in a current picture, the coded information indicating that the current block is coded by an intra prediction using a generalized linear angle intra prediction (GLAIP); determining a set of parameters for the GLAIP; and reconstructing the current block based on the intra prediction of the current block using the GLAIP with the set of parameters.

(61). The method of feature (60), in which the determining includes: deriving the set of parameters based on first reconstructed samples in a template of the current block and second reconstructed samples in a reference line of the template.

(62). The method of any of features (60) to (61), in which the set of parameters is at least one of: a set of angular with translation parameters; and a set of quadratic parameters.

(63). The method of any of features (60) to (62), in which the deriving includes at least one of: deriving the set of parameters using a linear model based derivation; and deriving the set of parameters using a non-linear least square based derivation.

(64). The method of any of features (60) to (63), further including at least one of: determining a prediction angle based on a derived decoder side intra mode derivation (DIMD) mode of the current block; deriving the prediction angle based on derived occurrence based intra mode coding (OBIC) derivation; and decoding the prediction angle from the coded video bitstream.

(65). The method of any of features (60) to (64), in which the template of the current block includes one or more rows above the current block, the reference line includes a row above the template, and the deriving includes: generating prediction samples for the first reconstructed samples based on the reference line by the intra prediction using the GLAIP; calculating a difference measure between the prediction samples and the first reconstructed samples; and deriving the set of parameters that minimizes the difference measure.

(66). The method of any of features (60) to (65), in which the template of the current block includes one or more columns left to the current block, the reference line includes a column left to the template, and the deriving includes: generating prediction samples for the first reconstructed samples based on the reference line by the intra prediction using the GLAIP; calculating a difference measure between the prediction samples and the first reconstructed samples; and deriving the set of parameters that minimizes the difference measure.

(67). The method of any of features (60) to (66), in which the determining includes: determining the set of parameters for the GLAIP according to one or more syntaxes in the coded information of the current block.

(68). The method of any of features (60) to (67), in which the determining includes: determining a first subset of the set of parameters for the GLAIP according to one or more syntaxes in the coded information of the current block; and deriving a second subset of the set of parameters based on first reconstructed samples in a template of the current block, second reconstructed samples in a reference line of the template, and the first subset of the set of parameters.

(69). The method of any of features (60) to (68), in which the determining includes: decoding a syntax that indicates a partition of the set of parameters into the first subset and the second subset.

(70). The method of any of features (60) to (69), in which the first subset includes a fixed number of parameters.

(71). A method of video encoding, including: determining to encode a current block in a current picture by an intra prediction using a generalized linear angle intra prediction (GLAIP); deriving a set of parameters for the GLAIP based on a reference line of the current block and the current block; and encoding the current block into coded information in a bitstream based on the intra prediction of the current block using the GLAIP with the set of parameters.

(72). The method of feature (71), in which the deriving includes: generating prediction samples for the current block based on the reference line by the intra prediction using the GLAIP; calculating a difference measure between the prediction samples and original samples in the current block; and deriving the set of parameters that minimizes the difference measure.

(73). The method of any of features (71) to (72), in which the encoding includes: including one of more syntax elements that indicate the set of parameters into the coded information in the bitstream.

(74). The method of any of features (71) to (73), in which the set of parameters is at least one of: a set of angular with translation parameters; and a set of quadratic parameters.

(75). The method of any of features (71) to (74), in which the deriving includes at least one of: deriving the set of parameters using a linear model based derivation; and deriving the set of parameters using a non-linear least square based derivation.

(76). The method of any of features (71) to (75), further including at least one of: determining a prediction angle based on a derived decoder side intra mode derivation (DIMD) mode of the current block; and deriving the prediction angle based on derived occurrence based intra mode coding (OBIC) derivation.

(77). The method of any of features (71) to (76), further including: deriving a prediction angle based on a rate-distortion optimization; and including a syntax element in the coded information of the current block, the syntax element indicating the prediction angle.

(78). A method of processing visual media data, the method including: processing a bitstream of visual media data according to a format rule, in which: the bitstream includes coded information of a current block in a current picture, the coded information indicating that the current block is coded by an intra prediction using a generalized linear angle intra prediction (GLAIP); and the format rule specifies that: a set of parameters for the GLAIP is determined; and the current block is reconstructed based on the intra prediction of the current block using the GLAIP with the set of parameters.

(79). A method of video decoding, including: receiving a coded video bitstream including coded information of a current block in a current picture, the coded information indicating that the current block is coded by an intra prediction with a plurality of candidate coding tools; calculating template matching costs respectively for the plurality of candidate coding tools according to one or more templates of the current block; determining a selected coding tool from the plurality of candidate coding tools at least partially based on the template matching costs of the plurality of candidate coding tools; and reconstructing the current block based on the intra prediction using the selected coding tool.

(80). A method of video encoding, including: determining to encode a current block in a current picture by an intra prediction with a plurality of candidate coding tools; calculating template matching costs respectively for the plurality of candidate coding tools according to one or more templates of the current block; determining a selected coding tool from the plurality of candidate coding tools at least partially based on the template matching costs of the plurality of candidate coding tools; and encoding the current block into coded information in a bitstream based on the intra prediction using the selected coding tool.

(81). A method of processing visual media data, the method including: processing a bitstream of visual media data according to a format rule, in which: the bitstream includes coded information of a current block in a current picture, the coded information indicating that the current block is coded by an intra prediction with a plurality of candidate coding tools; and the format rule specifies that: template matching costs respectively for the plurality of candidate coding tools are calculated according to one or more templates of the current block; a selected coding tool is determined from the plurality of candidate coding tools at least partially based on the template matching costs of the plurality of candidate coding tools; and the current block is reconstructed based on the intra prediction using the selected coding tool.

(82). A method of video decoding, including: receiving a coded video bitstream including coded information of a current block in a current picture, the coded information indicating that the current block is coded based on a pixelwise based blending with a plurality of models; deriving a reference sample value for a pixel sample in the current block; determining one or more blending weights based on the reference sample value and one or more thresholds; deriving modeling results of the pixel sample respectively according to the plurality of models; and reconstructing the pixel sample based on a blending of the modeling results, the modeling results being blended according to the one or more blending weights.

(83). A method of video encoding, including: determining to encode a current block based on a pixelwise based blending with a plurality of models; deriving a reference sample value for a pixel sample in the current block; determining one or more blending weights based on the reference sample value and one or more thresholds; deriving modeling results of the pixel sample respectively according to the plurality of models; and encoding the pixel sample based on a blending of the modeling results, the modeling results being blended according to the one or more blending weights.

(84). A method of processing visual media data, the method including: processing a bitstream of visual media data according to a format rule, in which: the bitstream includes coded information of a current block, the coded information indicating that the current block is coded based on a pixelwise based blending with a plurality of models; and the format rule specifics that: a reference sample value for a pixel sample in the current block is derived; one or more blending weights are determined based on the reference sample value and one or more thresholds; modeling results of the pixel sample are derived respectively according to the plurality of models; and the pixel sample is reconstructed based on a blending of the modeling results, the modeling results being blended according to the one or more blending weights.

(85). A method of video decoding, including: receiving a coded video bitstream including coded information of a current block in a current picture, the coded information indicating that the current block is coded based on an intra prediction with classification dependent intra prediction information; applying a classifier on neighboring reconstructed samples of the current block to derive a classification; determining specific intra prediction information of the current block based on the classification, the specific intra prediction information of the current block including at least one of a probability of an intra prediction mode for the current block, a ranking of intra prediction modes for the current block, a most probable intra prediction mode for the current block, and a most probable reference line for the current block; and reconstructing the current block based on the specific intra prediction information of the current block.

(86). A method of video encoding, including: determining to encode a current block by an intra prediction with classification dependent intra prediction information; applying a classifier on neighboring reconstructed samples of the current block to derive a classification; determining specific intra prediction information of the current block based on the classification, the specific intra prediction information of the current block including at least one of a probability of an intra prediction mode for the current block, a ranking of intra prediction modes for the current block, a most probable intra prediction mode for the current block, and a most probable reference line for the current block; and encoding the current block based on the specific intra prediction information of the current block.

(87). A method of processing visual media data, the method including: processing a bitstream of visual media data according to a format rule, in which: the bitstream includes coded information of a current block, the coded information indicating that the current block is coded based on an intra prediction with classification dependent intra prediction information; and the format rule specifies that: a classifier is applied on neighboring reconstructed samples of the current block to derive a classification; specific intra prediction information of the current block is determined based on the classification, the specific intra prediction information of the current block including at least one of a probability of an intra prediction mode for the current block, a ranking of intra prediction modes for the current block, a most probable intra prediction mode for the current block, and a most probable reference line for the current block; and the current block is reconstructed based on the specific intra prediction information of the current block.

(88). An apparatus for video decoding, including processing circuitry that is configured to perform the method of any of features (1) to (19).

(89). An apparatus for video encoding, including processing circuitry that is configured to perform the method of any of features (20) to (39).

(90). An apparatus for video decoding, including processing circuitry that is configured to perform the method of any of features (41) to (49).

(91). An apparatus for video encoding, including processing circuitry that is configured to perform the method of any of features (50) to (58).

(92). An apparatus for video decoding, including processing circuitry that is configured to perform the method of any of features (60) to (70).

(93). An apparatus for video encoding, including processing circuitry that is configured to perform the method of any of features (71) to (77).

(94). An apparatus for video decoding, including processing circuitry that is configured to perform the method of any of features (79).

(95). An apparatus for video encoding, including processing circuitry that is configured to perform the method of any of features (80).

(96). An apparatus for video decoding, including processing circuitry that is configured to perform the method of any of features (82).

(97). An apparatus for video encoding, including processing circuitry that is configured to perform the method of any of features (83).

(98). An apparatus for video decoding, including processing circuitry that is configured to perform the method of any of features (85).

(99). An apparatus for video encoding, including processing circuitry that is configured to perform the method of any of features (86).

(100). A non-transitory computer-readable storage medium storing instructions which when executed by at least one processor cause the at least one processor to perform the method of any of features (1) to (87).

What is claimed is:

1. A method of video decoding, comprising:
receiving a coded video bitstream comprising coded information of a current block in a current picture, the coded information indicating that the current block is coded by an intra prediction using an affine intra mode (AIM) model;
determining the affine intra mode model for applying on the current block;
determining at least a first intra angular mode for a first sample in the current block and a second intra angular mode for a second sample in the current block according to the affine intra mode model, the first intra angular mode being different from the second intra angular mode; and
reconstructing the current block based on the intra prediction using the affine intra mode model, the first sample being predicted based on the first intra angular mode and the second sample being predicted based on the second intra angular mode.

2. The method of claim 1, wherein the determining the affine intra mode model comprises at least one of:
deriving the affine intra mode model based on one or more intra angular modes associated with neighboring blocks of the current block; and
determining the affine intra mode model based on one or more syntaxes in the coded information of the current block.

3. The method of claim 1, wherein the affine intra mode model is used to derive at least one of an angle, vectors associated with the angle, one or more trigonometric function value of the angle for a location in the current block.

4. The method of claim 1, wherein the affine intra mode model is configured to derive an angle for a location in the current block, and the method further comprises:
determining an intra angular mode associated with the angle according to a predefined angle table that maps angles to intra angular modes.

5. The method of claim 1, wherein the coded information of the current block includes a flag that indicates whether the current block is coded by using the affine intra mode model.

6. The method of claim 1, wherein the determining the affine intra mode model further comprises:
deriving the affine intra mode model based on two or more control point intra modes (CPIMs), a CPIM being an intra angular mode associated with a neighboring block of the current block in the current picture.

7. The method of claim 6, wherein a first CPIM associated with a first neighboring block and a second CPIM associated with a second neighboring block are available, the deriving the affine intra mode model comprises:
deriving the affine intra mode model based on the first CPIM and the second CPIM.

8. The method of claim 6, wherein a first CPIM associated with a first neighboring block and a second CPIM associated with a second neighboring block are available, the deriving the affine intra mode model comprises:
deriving a third CPIM associated with a third neighboring block of the current block based on the first CPIM and the second CPIM; and
deriving the affine intra mode model based on the first CPIM, the second CPIM and the third CPIM.

9. The method of claim 6, wherein a first CPIM associated with a first neighboring block, a second CPIM associated with a second neighboring block and a third CPIM associated with a third neighboring block are available, the deriving the affine intra mode model comprises:
deriving the affine intra mode model based on the first CPIM, the second CPIM and the third CPIM.

10. The method of claim 6, wherein a plurality of CPIMs are available, the deriving the affine intra mode model comprises:
constructing a combination list from the plurality of CPIMs, the combination list comprising combination candidates of CPIMs, a combination candidate being a combination of two or three CPIMs from the plurality of CPIMs;
determining a selected combination candidate from the combination list based on an index that is signaled in the coded video bitstream; and
deriving the affine intra mode model based on the selected combination candidate.

11. The method of claim 1, wherein the determining the affine intra mode model comprises:
determining the affine intra mode model by a regression model using two or more intra angular modes associated with neighboring blocks of the current block.

12. The method of claim 6, further comprising:
when a first intra mode associated with a first neighboring block of the current block is not an angular mode, replacing the first intra mode with a second intra mode to be associated with the first neighboring block, the second intra mode being an angular mode, the second intra mode associated with the first neighboring block being one of the two or more CPIMs that are used to derive the affine intra mode model.

13. The method of claim 12, wherein the second intra mode is at least one of:
a default angular mode;
an angular mode that is derived by a decoder-side intra mode derivation from a template of the current block; and/or
an angular mode that is derived by a decoder-side intra mode derivation from a reference block of the current block, the reference block being indicated by at least one of a block vector and/or a motion vector.

14. The method of claim 1, wherein the determining the affine intra mode model further comprises at least one of:
determining the affine intra mode model based on a base intra angular mode and a delta value when the affine intra mode model is a 4-parameter model, the base intra angular mode and the delta value being decoded from the coded video bitstream; and
determining the affine intra mode model based on a base intra angular mode, a first delta value and a second delta value when the affine intra mode model is a 6-parameter model, the base intra angular mode, the first delta value and the second delta value being decoded from the coded video bitstream.

15. The method of claim 1, wherein the determining at least the first intra angular mode for the first sample and the second intra angular mode for the second sample comprises:
determining intra angular modes in a sample-wise for samples in the current block according to the affine intra mode model.

16. The method of claim 1, wherein the determining at least the first intra angular mode for the first sample and the second intra angular mode for the second sample comprises:
determining the first intra angular mode for a first subblock of the current block including the first sample, and the second intra angular mode for a second subblock of the current block including the second sample.

17. The method of claim 1, wherein the reconstructing comprises:
generating first predicted samples of a first line in the current block; and
generating second predicted samples of a second line in the current block by using the first predicted samples as reference samples.

18. The method of claim 1, wherein the determining at least the first intra angular mode for the first sample and the second intra angular mode for the second sample comprises:
deriving an angle-depending value for a sample in the current block, the angle-depending value indicating a prediction angle of the sample; and
when the prediction angle is out of an angle range of a set of intra angular modes, determining a specific intra angular mode for the sample, the specific intra angular mode being a clipped intra angular mode in the set of intra angular modes that has a closest mapping angle to the prediction angle.

19. A method of video encoding, comprising:
determining to code a current block in a current picture by an intra prediction using an affine intra mode model;
determining the affine intra mode model for applying on the current block;
determining at least a first intra angular mode for a first sample in the current block and a second intra angular mode for a second sample in the current block according to the affine intra mode model, the first intra angular mode being different from the second intra angular mode; and
encoding the current block into coded information of the current block based on the intra prediction using the affine intra mode model, the first sample being predicted based on the first intra angular mode and the second sample being predicted based on the second intra angular mode.

20. A method of processing visual media data, the method comprising:
processing a bitstream of visual media data according to a format rule, wherein:
the bitstream includes coded information of a current block in a current picture, the coded information indicating that the current block is coded by an intra prediction using an affine intra mode model; and
the format rule specifies that:
the affine intra mode model for applying on the current block is determined;
at least a first intra angular mode for a first sample in the current block and a second intra angular mode for a second sample in the current block are determined according to the affine intra mode model, the first intra angular mode being different from the second intra angular mode; and
the current block is reconstructed based on the intra prediction using the affine intra mode model, the first sample being predicted based on the first intra angular mode and the second sample being predicted based on the second intra angular mode.
